(19) United States
(12) Patent Application Publication
(10) Pub. No.: US 2024/0420544 A1
(43) Pub. Date: Dec. 19, 2024

(54) SYSTEMS AND METHODS FOR DEMAND DEPOSIT ACCOUNT AND WAGERING ACCOUNT ADMINISTRATION

(71) Applicant: Sightline Payments LLC, Las Vegas, NV (US)

(72) Inventors: Omer Sattar, Las Vegas, NV (US); Jamie B. Parks, Cold Spring, KY (US); Tamara R. Tenenbaum, Montreal (CA); Rose Zwirn, Freehold, NJ (US); Mandi C. Hart, Pompano Beach, FL (US)

(21) Appl. No.: 18/741,194

(22) Filed: Jun. 12, 2024

Related U.S. Application Data
(60) Provisional application No. 63/507,746, filed on Jun. 13, 2023.

(51) Int. Cl. G07F 17/32; G06Q 40/02; G06Q 50/34

(52) U.S. Cl. CPC G07F 17/3244; G06Q 40/02; G06Q 50/34; G07F 17/3237

(57) ABSTRACT

Systems and methods are disclosed for automatically synchronizing ledgers of two separate accounts, namely an account at a financial institution and a wagering account of a gaming environment, in real-time based on various activities, such as withdraws, wager events, demand deposit account activities, and the like. Such an approach minimizes costs associated with the fund transfer and management and reduces undesirable churning of funds. The real-time synchronization of the account ledgers can occur without the user necessarily being aware, thereby creating a frictionless and enjoyable experience for users of the online betting and gaming platform.

### CROSS-REFERENCE TO RELATED APPLICATIONS

This application claims priority to U.S. Patent Application Ser. No. 63/507,746, filed on Jun. 13, 2023, and entitled “SYSTEMS AND METHODS FOR DEMAND DEPOSIT ACCOUNT AND WAGERING ACCOUNT ADMINISTRATION,” the disclosure of which is incorporated herein by reference in its entirety.

### BACKGROUND

End users of computing devices connected to the internet can access other computing devices, such as servers, that are connected to the internet in order to provide a variety of services to the users. One such service is an online gaming platform that allows end users to manage a wagering account, place bets on a variety of events, such as sporting events, or otherwise engage in gaming activities. An online gaming platform typically provides a menu of betting options to end users, from which the end users select their bets. Online gaming platforms typically allow users to fund a wagering account hosted by the gaming operator. The user can deposit funds from one or more funding sources and then use the funds in the online wagering account for placing wagers.

While such configuration allows users to easily manage funds in their wagering account and place wagers within the online gaming platform, when the user wants to use the funds outside the online gaming platform they must request a withdrawal of the funds from the online gaming platform via electronic transfer, check, or other process. Such withdraw event comes at a cost to the online gaming platform (i.e., interchange fees or other processing fees may be incurred, lost interest revenue, etc.). Moreover, once the withdraw event is initiated by the user, it may be days or even longer before the user receives the funds. Should the user then wish to increase the balance of their online gaming account, they must again fund the account by transferring funds from a funding source. This typical churning of funds by users of the platform is both costly for the online gaming platform and inconvenient for the user.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts an example system diagram of an example online betting and gaming environment leveraging real-time ledger updating in accordance with one non-limiting embodiment.

FIG. 2 depicts another example system diagram of an example transaction facilitator enabling ledger updating over a closed-loop processing network in accordance with one non-limiting embodiment.

FIG. 3 schematically depicts a progression of a balance of an online wagering account of an online betting and gaming environment over time based various events in accordance with one non-limiting embodiment.

FIG. 4 is an example message sequence chart in accordance with one non-limiting embodiment.

FIG. 5 schematically depicts example interfaces of an online betting and gaming platform over time in accordance with one non-limiting embodiment.

FIG. 6 depicts another example system diagram of an example transaction facilitator enabling ledger updating over a closed-loop processing network in accordance with one non-limiting embodiment.

FIG. 7 depicts an example system diagram of an example betting and gaming environment with automated demand deposit account formation in accordance with one non-limiting embodiment.

FIG. 8 depicts another example system diagram of an example transaction facilitator enabling funds transfers over a closed-loop processing network in accordance with one non-limiting embodiment.

FIG. 9 schematically depicts a progression of a balance of a wagering account of a gaming environment and a balance of a demand deposit account over time based various events in accordance with one non-limiting embodiment.

FIG. 10 schematically depicts example interfaces of an online betting and gaming platform over time in accordance with one non-limiting embodiment.

FIG. 11 depicts an example system diagram of an example online betting and gaming environment leveraging zero-balance wagering accounts in accordance with one non-limiting embodiment.

FIG. 12 depicts another example system diagram of an example transaction facilitator enabling the use of universal demand deposit account over a closed-loop processing network in accordance with one non-limiting embodiment.

FIG. 13 schematically depicts a progression of a balance of zero-balance wagering accounts of a gaming environment and a balance of a demand deposit account over time based various events in accordance with one non-limiting embodiment.

FIG. 14 depicts an example system diagram for user demand deposit account formation and facilitating handoff of the user to gaming operators for offer redemption and wagering in accordance with one non-limiting embodiment.

FIG. 15 is an example message sequence chart in accordance with one non-limiting embodiment.

### DETAILED DESCRIPTION

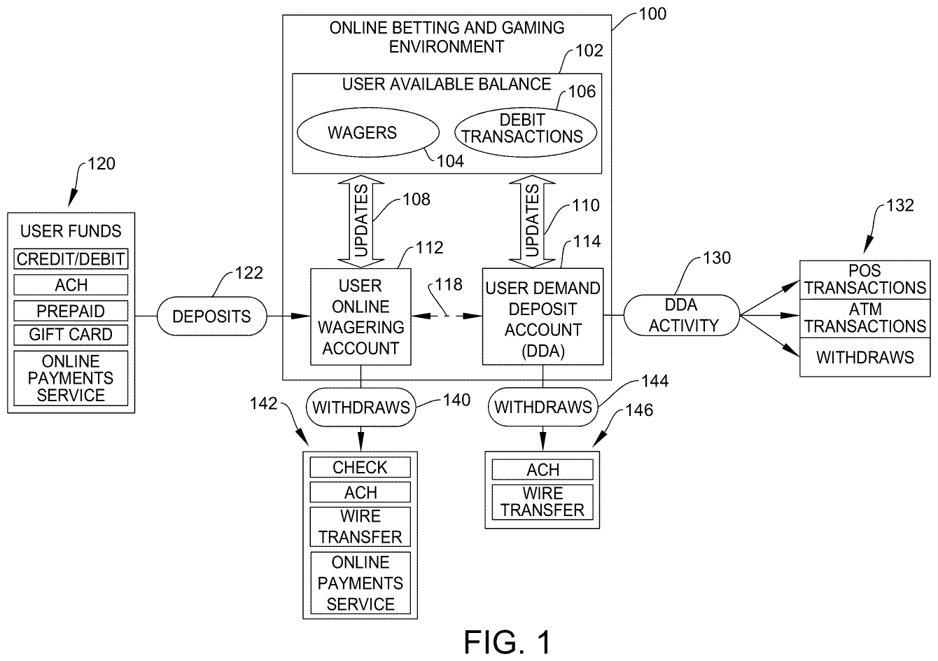

Various non-limiting embodiments of the present disclosure will now be described to provide an overall understanding of the principles of the structure, function, and use of systems, apparatuses, devices, and methods disclosed. One or more examples of these non-limiting embodiments are illustrated in the selected examples disclosed and described in detail with reference made to FIGS. 1-15 in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For case of reading and clarity, certain components, modules, or methods may be described solely in connection with a specific figure. In this disclosure, any identification of specific techniques, arrangements, etc., are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated if modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code, content such as text, video data, and audio data, among others, and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems, and can use other protocols, or operate at other layers in communication protocol stacks, than are described.

The apparatuses, devices, systems, and methods described herein can address the technical deficiencies of current online betting and gaming platforms with regard to user funds management. More particularly, in accordance with some embodiments, using specialized closed-loop network communications described herein, the ledgers of two separate accounts can be automatically synchronized in real-time based on various activities, such as withdraws, wager events, demand deposit account activities, and the like. Beneficially, such an approach minimizes costs associated with the fund transfer and management and also provides the online betting and gaming platform with additional user transaction information and revenue streams. Moreover, such approach technique for the real-time synchronization of the account ledgers can occur without the user necessarily being aware, thereby creating a frictionless and enjoyable experience for users of the online betting and gaming platform. In other embodiments, a demand deposit account can be created on a first platform and a wagering account can be created on a second platform for a user. The user can selectively transfer funds between the accounts using specialized closed-loop network communications. This approach also minimizes costs associated with the fund transfer and management, readily provides access to their funds, and also provides gaming operators with additional user transaction information and revenue streams. In other embodiments, a demand deposit account serving as a universal wallet can be created on a first platform. One or more jurisdiction-specific zero balance wagering accounts can be created for the user on a second platform. Funds can be transferred between the universal wallet and each of the jurisdiction-specific zero balance wagering accounts, depending on the physical location of the user, using specialized closed-loop network communications. Moreover, in some embodiments, instead of having a one-to-one relationship between a demand deposit account and an associated wagering account, a one-to-many relationship can be used, such that funs can be transferred between a single demand deposit account and any of a plurality of wagering accounts hosted by various gaming operators, for example.

In accordance with the present disclosure, a user can create a user account on an online gaming platform and various enrollment processes, such as a Know Your Customer (KYC) process, can be performed during the account formation stage. A wagering account can be formed for the user and once the wagering account is formed, the user can load funds into the wagering account that can be used for wagering on the platform, as is generally known in the art. Uniquely, though, in accordance with the present disclosure, a demand deposit account (DDA) at a financial institution can also be opened on behalf of the user that is enrolling on the online betting and gaming platform. This account formation process can be automatically completed via application programming interface (API) calls to the financial institution, for example. The formation of the DDA can be contingent upon the user satisfying the KYC processing performed by the online platform during the enrollment process. In some embodiments, a payment vehicle associated with the DDA, sometimes referred to as a checking account, can also be issued or otherwise provided to the user. Such payment vehicle can be any suitable type of vehicle, including physical or virtual, that allows the user to initiate payment transactions through conventional open-loop payment networks (i.e., MasterCard, Amex, Discover, or Star) using funds held in the DDA.

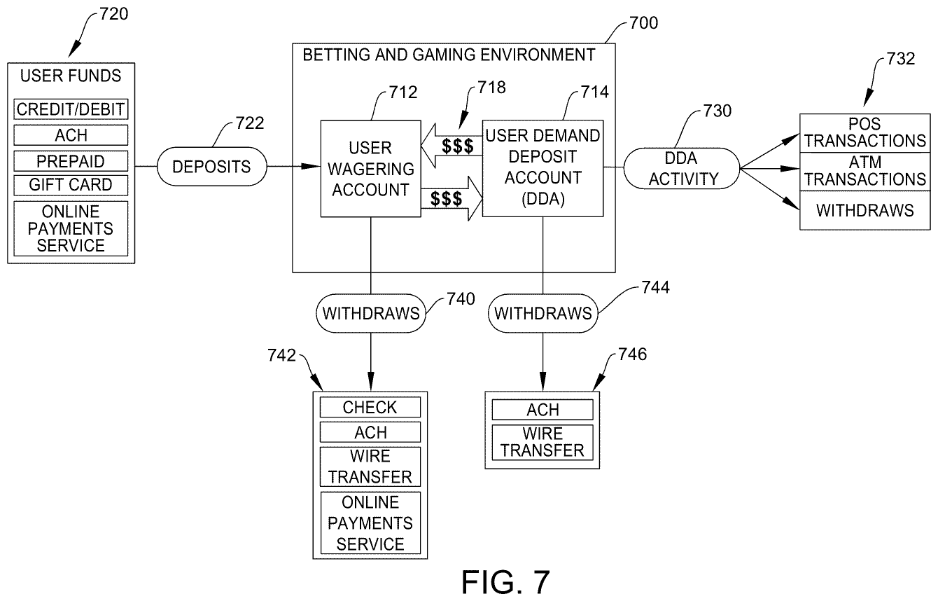

In accordance with some embodiments, although multiple accounts are created on behalf of the user in accordance with the present disclosure (i.e., an online wagering account and a DDA), from the perspective of the user that is interacting with the online betting and gaming platform, a singular available balance amount is displayed. In other words, the online betting and gaming platform may indicate the user has a balance of $500. In accordance with the present disclosure, this $500 balance can optionally be used for wagering on the platform, or the user could make a purchase with their payment vehicle for up to $500. In either event, the available balance displayed to the user would be decreased in real-time based on the amount of the wager and/or the amount of the purchase. Additional details regarding the automated real-time messaging between the online betting and gaming platform and the financial institution that enables the real-time ledger updating are provided below. In accordance with other embodiments, as described below with reference to FIGS. 7-10, for example, a user can be informed of the balance of both accounts and selectively and intentionally transfer funs between the two.

FIG. 1 depicts an example system diagram of an example online betting and gaming environment 100 leveraging real-time ledger updating in accordance with one non-limiting embodiment. Subsequent to an enrollment process, two accounts can be created on behalf of a user, namely an online wagering account 112 and a user demand deposit account (DDA) 114. The DDA 114 can be created at a financial institution and enjoy various benefits, such as deposit insurance provided by the Federal Deposit Insurance Corporation (FDIC). Additionally, funds in the DDA can be withdrawn at any time without advance notice required and typically have no limitations on withdrawals or transfer. Upon creation of the DDA 114, in some embodiments a payment vehicle can be issued to the user (or otherwise provisioned) to allow for ease of access to the funds in the DDA 114.

Through interactions with the online betting and gaming environment 100, such as via an interface presented on a user communications device, the user can initiate deposits 122 into their online wagering account 112 from a source of user funds 120. While FIG. 1 schematically illustrates credit/debit, ACH, prepaid accounts, gift card accounts, online payment service (i.e., VENMO, PAYPAL, and the like) as example user fund sources, any suitable source of user funds 120 can be leveraged.

Upon depositing the funds, the user available balance 102 can be updated to reflect the deposit. The user available balance 102 can be a dollar amount graphically presented to the user on the interface of the online betting and gaming environment 100, for example. Upon receipt of the deposits 112, the ledger of the DDA 114 can also be updated, represented by synchronization messaging 118, to automatically increase the amount of funds usable in the DDA for DDA activity. Thus, the funds represented by the user available balance 102 can be used either for wagers 104 or debit transactions 106, each of which would be reflected in a decrease in the user available balance 102.

More particularly the user does not have to proactively “move” or “transfer” funds from one account to the other before using the funds. If a wager 104 is placed by the user, a ledger update 110 can be provided to the DDA 114 to automatically decrease the available balance of the DDA 114. Similarly, if DDA activity 130 occurs, a ledger update 108 can be provided to the online wagering account 112 to automatically decrease the available balance of the DDA 114. While a variety of DDA activities 130 can occur, example types of transaction 132 are illustrated as point of sale (POS) transactions, ATM transactions, and withdrawals. Notably, based on the interplay between the two accounts and the real-time ledger updating messaging therebetween, the user of the online betting and gaming environment 100 can simply be provided with a single available balance amount 102, as opposed to, for example, an amount of funds available in the online wagering account 112 and the amount of funds available in the DDA 114.

Finally, as is schematically shown in FIG. 1, in accordance with various embodiments, the online betting and gaming environment 100 can allow for funds withdraws 140 from the online wagering account 112. Example withdraw types 142 include check, ACH, wire transfer, and online payment services. The online betting and gaming environment 100 can also allow for fund withdrawals 144 from the DDA 114. Example withdraw types 146 include check, ACH and wire transfer. As is to be appreciated, any withdrawal from one account can initiate an automatic ledger update to synchronize the available balance for wagers 104 or debit transactions 106.

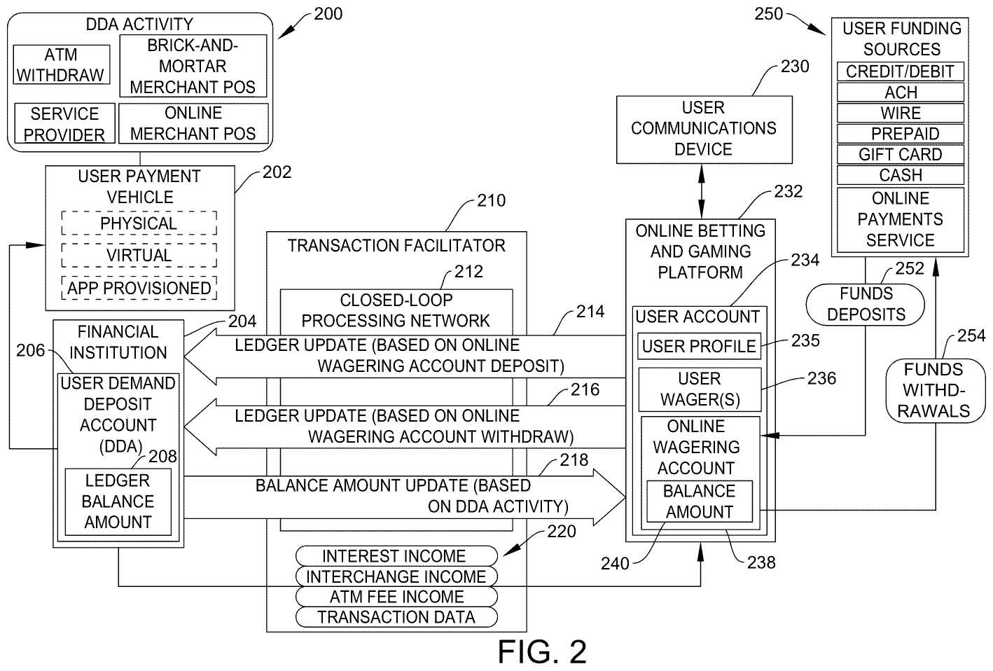

FIG. 2 depicts another example system diagram of an example transaction facilitator 210 enabling ledger updating over a closed-loop processing network 212 in accordance with one non-limiting embodiment. In some embodiments, the closed-loop processing network 212 is SPAN, a priority bi-directional closed loop network, operated by Sightline Payments LLC. The closed-loop processing network 212 can allow for closed, secure messaging between a financial institution 204 and the online betting and gaming platform 232. Such messaging can be used to provide ledger updates based on wagering activity and DDA activity of a user.

In accordance with some embodiments, a user can initially interact with the online betting and gaming platform 232 via a user communication device 230. The user communication device 230 can be, for example, a smartphone, laptop computer, tablet computer, desktop computer, gaming console, VR console, kiosk, or any other communications device that can enable suitable network communications with the online betting and gaming platform 232. In some embodiments, the user can download a mobile application on their user communication device 230 allowing them to interact with the online betting and gaming platform 232. In some embodiments, the user may navigate to a website using a web browser application on their user communication device 230 to interact with the online betting and gaming platform 232. In some embodiments, the user communication device 230 can be a kiosk or dedicated handheld device that is specially configured to interact with the online betting and gaming platform 232. In any event, the user can interact with the online betting and gaming platform 232 and begin an enrollment process.

During the enrollment process, information can be collected from the user that seeks to reduce fraud and money laundering and identify terrorist financing. Gathering information such as name, date of birth, address, identification number, etc. may be required to comply with various regulations and is generally referred to as a Know Your Customer (KYC) process. Once the user has satisfied the KYC process, as well as any other enrollment procedures of the online betting and gaming platform 232, a user account 234 can be created. As part of the enrollment process, an online wagering account 238 can be created for the user, which has a balance amount 240. The online betting and gaming platform 232 can be the system of record for the account and the online wagering account 238 can be tied to a user account 234. The user account 234 can generally include or otherwise be associated with a user profile 235, a tracking of the user's wagers 236, and the online wagering account 238.

In accordance with the present disclosure, upon satisfying the KYC process, the transaction facilitator 210 can create a DDA 206 at the financial institution 204 on behalf of the user. More particularly, information collected by the online betting and gaming platform 232 during the enrollment process can be passed to the financial institution 204 by the transaction facilitator 210 via API calls, or other suitable techniques. In some embodiments, a user payment vehicle 202 can be issued to the user that is associated with the DDA 206. The type of payment vehicle 210 issued to the user can vary based on implementation, but in some embodiments the payment vehicle is a physical card, a virtual card, and/or a payment vehicle provisioned in a mobile application. Moreover, in some embodiments the payment vehicle 202 can be branded with a brand associated with the online betting and gaming platform 232, for example. The DDA 206 can have a ledger balance amount 208, which represents the balance of funds available to the user for withdrawal or other DDA activities 200, such as POS transactions, payment for services, online transactions, ATM withdrawals, and so forth.

In accordance with the present embodiment, the ledger balance amount 208 and the balance amount 240 can be synchronized via real-time updating through the closed-loop processing network 212. For example, the balance amount 240 of the online wagering account 238 may be $0.00 when initially created, although in some cases, various types of promotions may pre-fund the wagering account 238 as an incentive. The user can increase the balance amount 240 with a fund deposit 252 from any of a variety of user funding sources 250. By way of example, via interactions with an interface of the online betting and gaming platform 232, the user can provide information for a credit or debit card, or other funding source. Non-limiting examples of funding sources 250 are schematically depicted in FIG. 2. Upon receiving the funds into the online wagering account 238, the balance amount 240 can be increased and be made available for wagering. Additionally, a ledger update 214 can be sent to the financial institution through the closed-loop processing network 212 with information regarding the deposit. More particularly, the ledger balance amount 208 can be increased based on the ledger update 214. Thus, if the user had deposited $100 into the online wagering account 238, the ledger update 214 would cause the ledger balance amount 208 to be increased by $100. Subsequently, when the user places a wager 236, the balance amount 240 can be reduced by the amount of the wager. A ledger update 216 can also be sent to the financial institution 204 through the closed-loop processing network 212 with information regarding the withdraw from the online wagering account 240. Thus, if the user had placed a $20 wager, the balance amount 240 would be reduced to $80 and in substantially real-time the ledger balance amount 208 of the DDA 206 would also reflect a balance of $80. A ledger update 216 can also be sent to the financial institution 204 through the closed-loop processing network 212 with information regarding a withdrawal of funds 254 from the online wagering account 238 by the user.

The user can also utilize the payment vehicle 202 for various DDA activity 200, such as ATM withdraws, point-of-sale transactions, and so forth. At least some of these transactions can be open-loop credit or debit transactions. The user can also optionally withdraw funds from the DDA 206 using ACH transfers, wire transfers, and the like. In any event, any such DDA activity 200 will decrease the ledger balance amount 208. In response to the DDA activity 200, therefore, a balance amount update 218 can be sent to the online betting and gaming platform 232 through the closed-loop processing network 212. Based on the balance amount update 218, the online betting and gaming platform 232 can reduce the balance amount 240 in the online wagering account 238 for the user. By way of example, if the user had made a $20 cash withdraw from an ATM, the ledger balance amount 208 would be reduced from $80 to $60. The balance amount update 218 would also indicate the balance amount 240 of the user's online wagering account 238 should be reduced to $60. Accordingly, the user would only be able to place up to one or more wagers totaling up to $60. Such updates 214, 216, and 218 can be transmitted in real-time based on the various activities of the user, such that the balances of the DDA 206 and the online wagering account 238 are synchronized. The user can beneficially have access to their funds via either DDA activity, wager activity, DDA withdraws, or wagering account withdraws without the user needing to actively instruct any transfer of funds between their various accounts.

Moreover, in some embodiments, the online betting and gaming platform 232 can enjoy a number of benefits from the system and methods described herein, including additional revenue and consumer data 220. Not only can patron churning of funds be reduced, the online betting and gaming platform 232 can receive at least some interest income on the DDAs of its user base, as well as receive at least some interchange income from a user's use of the payment vehicle 202, as well as at least some of the ATM fees charged to the user during ATM transactions. Additionally, the online betting and gaming platform 232 can receive insightful data on the user's spending habits, including where, when, and how users spend the funds in their DDA. Such data can be gleaned from the transaction information that is collected when a user utilizes their payment vehicle 202 to access funds in the DDA 206. This information can include merchant identifiers, merchant category codes, transaction amounts, transaction dates, and so forth.

As provided above, the transaction facilitator 210 can be closed communication with the online betting and gaming platform 232 that maintains the wagering account 238 and the financial institution 204 that maintains the DDA 206. It is noted that while the transaction facilitator 210 is schematically illustrated as a single entity in this figure and other various embodiments described herein, it is to be appreciated that this disclosure is not so limited. Instead, the functionality of the transaction facilitator 210, as described herein, can be distributed across, or otherwise performed by, a plurality of various entities, such payment gateways, acquirer processors, and other types of payment intermediaries. Also, the transaction facilitator 210, or at least components thereof, can reside within the online betting and gaming platform 232 or be controlled by an operator of the online betting and gaming platform 232. In such embodiment, the transaction facilitator 210 can be configured to communicate with the financial institution 204 through a secured communication link. Further, the transaction facilitator 210, or at least components thereof, can be controlled by the financial institution 204. Therefore, the transaction facilitator 210 may be operated by, or otherwise controlled by a variety of different entities. The transaction facilitator 210 can also have a one-to-one processing relationship with the online betting and gaming platform 232, as illustrated. It is to be appreciated, however, that the transaction facilitator 210 can also have a one-to-many configuration such that it has a processing relationship with a plurality of different online betting and gaming platforms. The transaction facilitator 210 can include one or more processors and one or more computer memory units. The processor 722 can execute software instructions stored on the memory unit. The one or more processors can be implemented as an integrated circuit (IC) having one or multiple cores. The memory unit can include volatile and/or non-volatile memory units. Volatile memory units can include random access memory (RAM), for example. Non-volatile memory units can include read only memory (ROM), for example, as well as mechanical non-volatile memory systems, such as, for example, a hard disk drive, an optical disk drive, etc. The RAM and/or ROM memory units can be implemented as discrete memory ICs, for example.

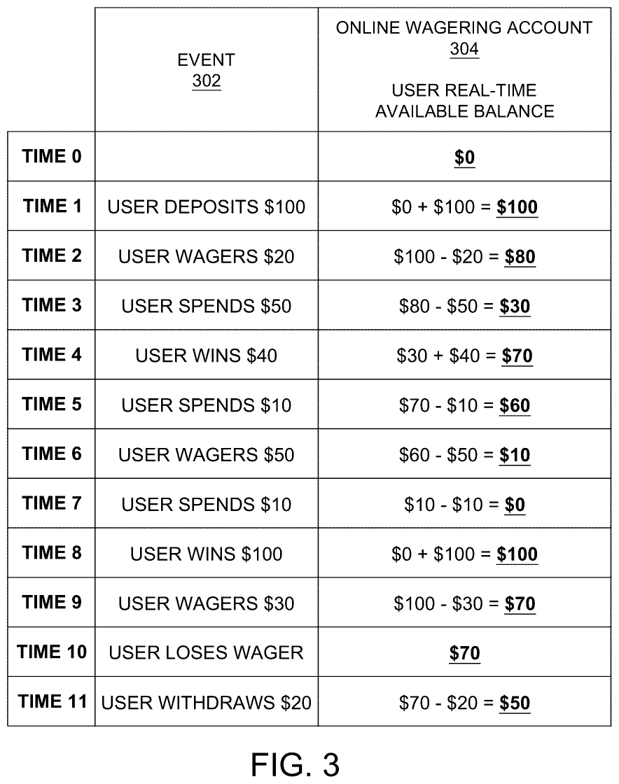

FIG. 3 schematically depicts a progression of a balance of an online wagering account 304 of an online betting and gaming environment over time based on various events 302 in accordance with one non-limiting embodiment.

At Time 0, the real-time available balance of the online wagering account is $0.00. This may occur, for example, at the account formation stage or after a user has depleted their balance.

At Time 1, the user deposits $100 from a funding source, such as a credit/debit card, an ACH transfer, or other suitable source. Accordingly, the real-time available balance of the online wagering account is increased to $100.

At Time 2, the user wagers $20 on a sporting event, or other gaming activity, via interactions with the online betting and gaming environment. Accordingly, the real-time available balance of the online wagering account is decreased to $80.

At Time 3, the user spends $50 using their payment vehicle. Accordingly, the real-time available balance of the online wagering account is decreased to $30.

At Time 4, the user wins $40 based on a wager placed at Time 2. Accordingly, the real-time available balance of the online wagering account is increased to $70.

At Time 5, the user spends $10 using their payment vehicle. Accordingly, the real-time available balance of the online wagering account is decreased to $60.

At Time 6, the user wagers $50 via interactions with the online betting and gaming environment. Accordingly, the real-time available balance of the online wagering account is decreased to $10.

At Time 7, the user spends $10 using their payment vehicle. Accordingly, the real-time available balance of the online wagering account is decreased to $10.

At Time 8, the user wins $100 based on a wager placed at Time 6. Accordingly, the real-time available balance of the online wagering account is increased to $100

At Time 9, the user wagers $30 via the interactions with the online betting and gaming environment. Accordingly, the real-time available balance of the online wagering account is decreased to $70.

At Time 10, the user loses the wager placed at Time 9. Since the funds associated with the wager had already been withdrawn from the wagering account, this loss does not impact the balance of the online wagering account and the balance remains at $70.

At Time 11, the user withdraws $20 at an ATM. Accordingly, the real-time available balance of the online wagering account is decreased to $50.

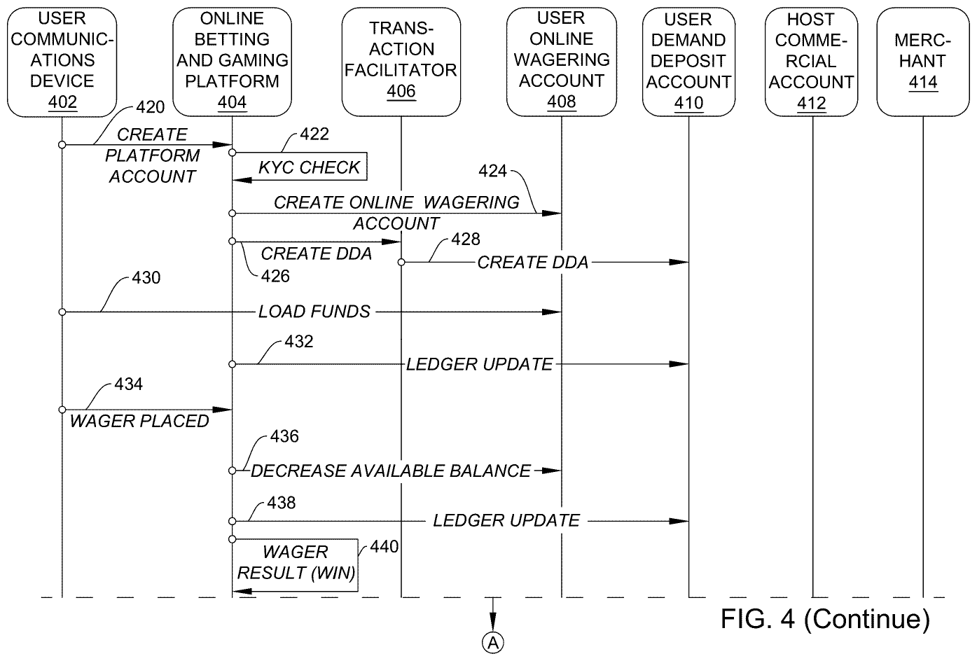

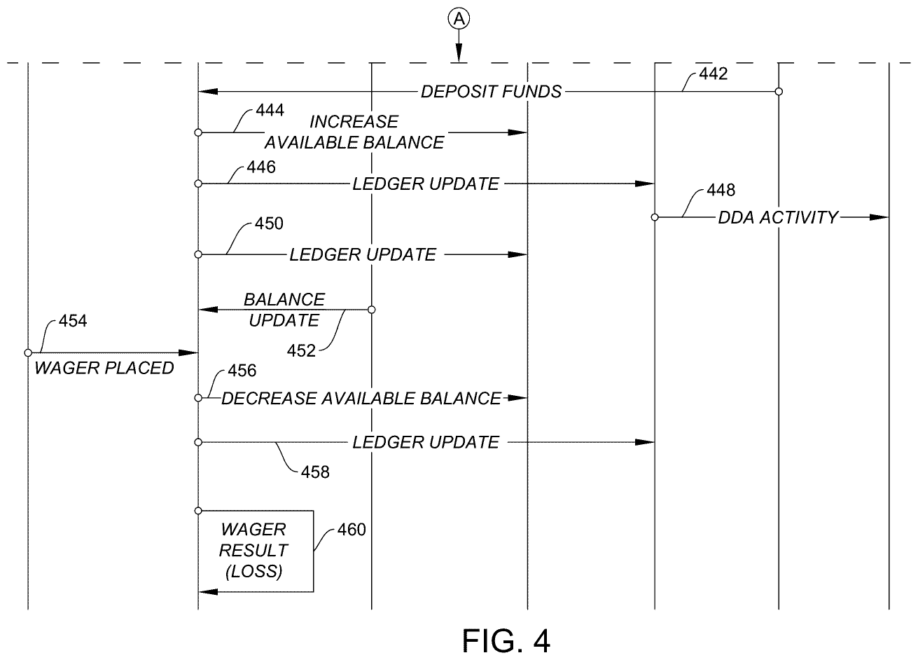

FIG. 4 is an example message sequence chart (MSC) in accordance with one non-limiting embodiment. The MSC schematically depicts a user communications device 402, an online betting and gaming platform 404, a transaction facilitator 406, an online wagering account 408 of the user of the user communications device 402, a DDA 410 of the user of the user communications device 402, a host commercial account 412 of the online betting and gaming platform 404, and a merchant 414.

At 420, the user creates a platform account through interactions with the online betting and gaming platform 404 via their user communications device 402. In some embodiments, the user may download an application onto their user communications device 402, while in other embodiments the user may navigate to a website hosted by the online betting and gaming platform 404, for example.

At 422, a KYC check is performed on the user. As is to be appreciated, this process service to identify and verify the identity of the user of the user communications device 402.

At 424, based on a successful KYC process, an online wagering account 408 is created for the user of the user communications device 402.

At 426, based on a successful KYC process, the online betting and gaming platform 404 can instruct the transaction facilitator 406 to create a DDA for the user communications device 402 and provide information regarding the user to the transaction facilitator 406.

At 428, the transaction facilitator 406 communicates with a financial institution to create a DDA 410 for the user of the user communications device 402.

At 430, the user of the user communications device 402 loads funds into their online wagering account 408 from a funding source, which increases the balance of that account.

At 432, responsive to the deposit of funds, a ledger update is provided to the DDA 410. This ledger update can be provided in substantially real-time such that the ledger DDA is updated without an artificial pause or delay.

At 434, the user of the user communications device 402 places a wager on the online betting and gaming platform 404.

At 436, the online betting and gaming platform 404 causes a decrease in the available balance of the online wagering account 408, wherein the amount the available balance is decreased is equal to the amount of the wager 434.

At 438, based on the wager 434, a ledger update is also provided to the DDA 410 such that available balance of the DDA 410 is decreased by an amount equal to the amount of the wager 434.

At 440, the wager 434 is deemed to be a winning wager (i.e., based on the outcome of a sporting event).

At 442, responsive to the amount of funds owed to the user of the user communications device 402 due to the winning wager, funds from the host commercial account 412 are transferred to the online betting and gaming platform 404 such that, at 444, the balance of the online wagering account 408 can be increased.

At 446, based on the deposit to the online wagering account 408, another ledger update is provided to the DDA 410 such that the available balance of the DDA 410 is increased by the amount that was received from the host commercial account 412.

At 448, the user of the user communications device 402 initiates DDA activity at the merchant 414, such as a purchase event at a point-of-sale device.

At 450, a ledger update is provided to the online wagering account 408 such that the available balance is reduced by the amount of funds used at the purchase event at the point-of-sale device.

At 452, the updated balance is provided to the online betting and gaming platform 404 such that it can be displayed to the user of the user communications device 402, for example.

At 454, the user of the user communications device 402 places another wager on the online betting and gaming platform 404.

At 456, the online betting and gaming platform 404 causes a decrease in the available balance of the online wagering account 408, wherein the amount the available balance is decreased is equal to the amount of the wager 456

At 458, based on the wager 454, a ledger update is provided to the DDA 410 such that the available balance of the DDA 410 is decreased by an amount equal to the amount of the wager 454.

At 460, the wager 454 is deemed to be a losing wager. This determination does not have an impact on the balances of the accounts, as the wager had previously been accounted for.

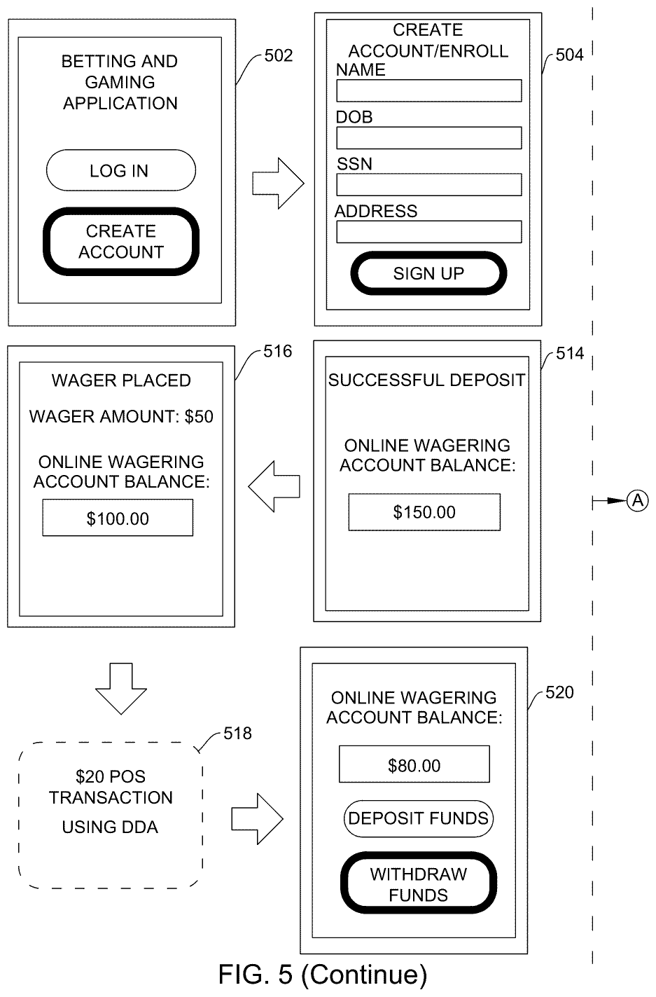

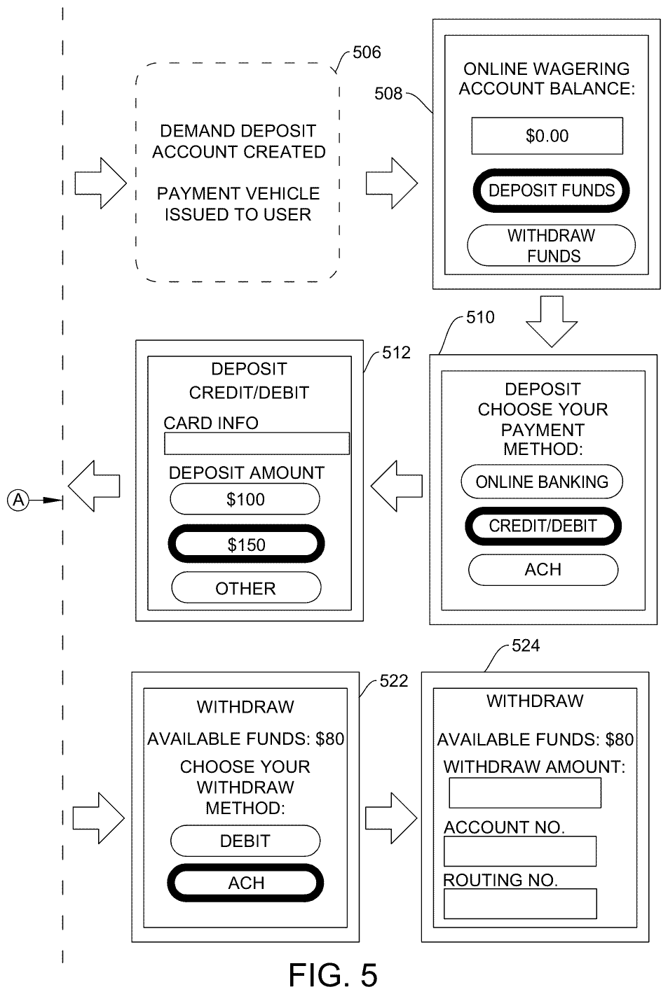

FIG. 5 schematically depicts example interfaces of online betting and gaming platforms over time in accordance with one non-limiting embodiment. The interfaces can be presented, for example, on a communication device operated by a user. At interface 502, the user is presented with the option to log in or create an account with the online betting and gaming platform. The “create account” option is selected, which causes interface 504 to be presented to the user. The interface 504 can request information from the user that is necessary for the account creation process. Once the required information has been provided by the user, the user can select the “sign up” feature. As provided above, attempting to create an account on the online betting and gaming platform can trigger a KYC check. Once the KYC check is satisfied, a demand deposit account can be created at 506. Additionally, as shown, a payment vehicle associated with the demand deposit account can be issued to the user. At interface 508, a balance amount of the user's online wagering account is presented to the user and the user has selected the “deposit funds” option. Selecting the deposit funds option can cause interface 510 to be displayed, which generally allows the user to identify the type of funding source. Selecting the “credit/debit” funding source can cause interface 512 to be displayed which generally allows the user to input information regarding the fund source (such as card number, expiration date, CCV, etc.). As is to be appreciated, the particular information requested via the interface will depend on the type of funding source. In the illustrated embodiment, the user has opted to fund the wagering account with an initial deposit of $150 from the funding source. After the transaction has been processed, interface 514 can convey to the user that the wagering account balance has been increased by the amount of funds deposited. At interface 516, the user has placed a wager on the online betting and gaming platform and the wagering account balance has been decreased accordingly.

At interface 518, the user has used the payment vehicle associated with the DDA for a purchase transaction. Based on the real-time ledger updating described above, the available balance of the online wagering account can be reduced, as shown by interface 520. The user can optionally “withdraw funds,” as shown in interface 520. At interface 522, the user can be presented with withdraw options, with the “ACH” option being selected in FIG. 5. At interface 524, the issue can enter the withdraw amount (i.e., any amount up to and including the available balance amount) and enter details regarding the withdraw method.

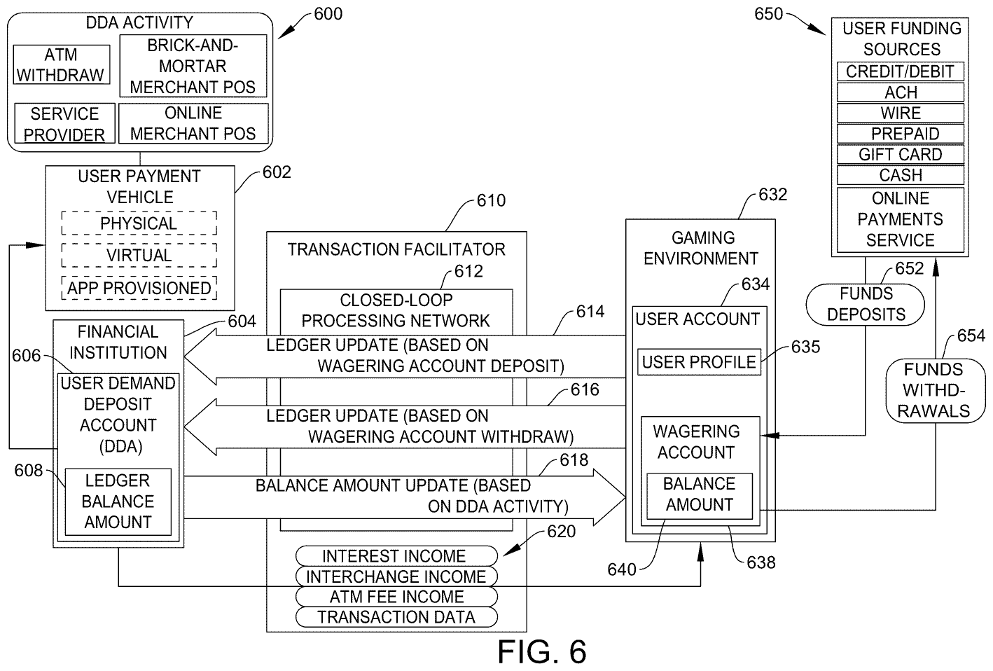

FIG. 6 depicts another example system diagram of an example transaction facilitator 610 enabling ledger updating over a closed-loop processing network 612 in accordance with one non-limiting embodiment. In some embodiments, the closed-loop processing network 612 is SPAN, a priority bi-directional closed loop network, operated by Sightline Payments LLC. The closed-loop processing network 612 can allow for closed, secure messaging between a financial institution 604 and a gaming environment 632, which can be associated with, for example, a brick-and-mortar gaming environment (i.e., a physical casino). Such messaging can be used to provide ledger updates based on wagering activity and DDA activity of a user. In other embodiments, the gaming environment 632, can be associated with a non-physical casino, such as an online casino or other type of iGaming environment.

In accordance with some embodiments, a user can initially interact with the gaming environment 632 to begin an enrollment process, such as enrollment into a loyalty program of the gaming environment 632. Such enrollment process can occur, for example, at a casino cage, a kiosk, an online device, or using any other suitable approach. During the enrollment process, information can be collected from the user that seeks to reduce fraud and money laundering and identify terrorist financing. Gathering information such as name, date of birth, address, identification number, etc. may be required to comply with various regulations and is generally referred to as a Know Your Customer (KYC) process. Once the user has satisfied the KYC process, as well as any other enrollment procedures of the gaming environment 632, a user account 634 can be created. As part of the enrollment process, a wagering account 638 can be created for the user, which has a balance amount 640. The gaming environment 632 can be the system of record for the account and the wagering account 638 can be tied to a user account 634. The user account 634 can generally include or otherwise be associated with a user profile 635 and the wagering account 638.

In accordance with the present disclosure, upon satisfying the KYC process, the transaction facilitator 310 can create a DDA 604 at the financial institution 604 on behalf of the user. More particularly, information collected by the gaming environment 632 during the enrollment process can be passed to the financial institution 604 by the transaction facilitator 610 via API calls, or other suitable techniques. In some embodiments, a user payment vehicle 602 can be issued to the user that is associated with the DDA 606. The type of payment vehicle 610 issued to the user can vary based on implementation, but in some embodiments the payment vehicle is a physical card, a virtual card, and/or a payment vehicle provisioned in a mobile application. Moreover, in some embodiments the payment vehicle 602 can be branded with a brand associated with the gaming environment 632, for example. The DDA 604 can have a ledger balance amount 608, which represents the balance of funds available to the user for withdrawal or other DDA activities 600, such as POS transactions, payment for services, online transactions, ATM withdrawals, and so forth.

In accordance with the present embodiment, the ledger balance amount 608 and the balance amount 640 can be synchronized via real-time updating through the closed-loop processing network 612. For example, the balance amount 640 of the wagering account 638 may be $0.00 when initially created, although in some cases, various types of promotions may pre-fund the wagering account 638 as an incentive. The user can increase the balance amount 640 with a fund deposit 652 from any of a variety of user funding sources 650. By way of example, via interactions with an interface of the gaming environment 632, the user can provide information for a credit or debit card, or other funding source. Non-limiting examples of funding sources 650 are schematically depicted in FIG. 6. Upon receiving the funds into the wagering account 638, the balance amount 640 can be increased and be made available for wagering. Additionally, a ledger update 614 can be sent to the financial institution through the closed-loop processing network 612 with information regarding the deposit. More particularly, the ledger balance amount 608 can be increased based on the ledger update 614. Thus, if the user had deposited $100 into the wagering account 638, the ledger update 614 would cause the ledger balance amount 608 to be increased by $100. Subsequently, when the user places a wager, the balance amount 640 can be reduced by the amount of the wager. A ledger update 616 can also be sent to the financial institution 604 through the closed-loop processing network 612 with information regarding the withdraw from the wagering account 640. Thus, if the user had placed a $20 wager, the balance amount 640 would be reduced to $80 and in substantially real-time the ledger balance amount 608 of the DDA 206 would also reflect a balance of $80. A ledger update 616 can also be sent to the financial institution 604 through the closed-loop processing network 612 with information regarding a withdrawal of funds 654 from the wagering account 638 by the user.

The user can also utilize the payment vehicle 602 for various DDA activity 600, such as ATM withdraws, point-of-sale transactions, and so forth. At least some of these transactions can be open-loop credit or debit transactions. The user can also optionally withdraw funds from the DDA 606 using ACH transfers, wire transfers, and the like. In any event, any such DDA activity 600 will decrease the ledger balance amount 608. In response to the DDA activity 200, therefore, a balance amount update 618 can be sent to the gaming environment 632 through the closed-loop processing network 612. Based on the balance amount update 618, the gaming environment 632 can reduce the balance amount 640 in the wagering account 638 for the user. By way of example, if the user had made a $20 cash withdraw from an ATM, the ledger balance amount 608 would be reduced from $80 to $60. The balance amount update 618 would also indicate the balance amount 640 of the user's wagering account 638 should be reduced to $60. Accordingly, the user would only be able to place up to one or more wagers totaling up to $60. Such updates 614, 616, and 618 can be transmitted in real-time based on the various activities of the user, such that the balances of the DDA 606 and the wagering account 638 are synchronized. The user can beneficially have access to their funds via either DDA activity, wager activity, DDA withdraws, or wagering account withdraws without the user needing to actively instruct any transfer of funds between their various accounts.

Moreover, in some embodiments, the gaming environment 632 can enjoy a number of benefits from the system and methods described herein, including additional revenue and consumer data 620. Not only can patron churning of funds be reduced, the gaming environment 632 can receive at least some interest income on the DDAs of its user base, as well as receive at least some interchange income from a user's use of the payment vehicle 602, as well as at least some of the ATM fees charged to the user during ATM transactions. Additionally, the gaming environment 632 can receive insightful data on the user's spending habits, including where, when, and how users spend the funds in their DDA. Such data can be gleaned from the transaction information that is collected when a user utilizes their payment vehicle 602 to access funds in the DDA 606. This information can include merchant identifiers, merchant category codes, transaction amounts, transaction dates, and so forth.

FIG. 7 depicts an example system diagram of an example betting and gaming environment 700 with automated demand deposit account formation in accordance with one non-limiting embodiment. Subsequent to an enrollment process, two accounts can be created on behalf of a user, namely a wagering account 712 and a user demand deposit account (DDA) 714. The DDA 714 can be created at a financial institution and enjoy various benefits, such as deposit insurance provided by the Federal Deposit Insurance Corporation (FDIC). Additionally, funds in the DDA can be withdrawn at any time without advance notice required and typically have no limitations on withdrawals or transfer. Upon creation of the DDA 714, in some embodiments a payment vehicle can be issued to the user (or otherwise provisioned) to allow for case of access to the funds in the DDA 714.

Through interactions with the online betting and gaming environment 700, such as via an interface presented on a user communications device, the user can initiate deposits 722 into their wagering account 712 from a source of user funds 720. While FIG. 7 schematically illustrates credit/debit, ACH, prepaid accounts, gift card accounts, online payment service (i.e., VENMO, PAYPAL, and the like) as example user fund sources, any suitable source of user funds 720 can be leveraged. Upon depositing the funds, the available balance in the wagering account 712 can be updated to reflect the deposit. The available balance of the wagering account 712 can be a dollar amount graphically presented to the user on the interface of the online betting and gaming environment 700, for example. Optionally, as described in more detail below, the user can elect to transfer some or all of the funds in the wagering account 712 to the DDA 714 via transfers 718. As such the balance of the DDA 714 will be shown to increase by the same amount that the wagering account 712 is decreased. Such transfer 718 can occur via a closed-loop network established between the betting and gaming environment 700 and the financial institution holding the DDA 714 to minimize the costs associated with the transaction. Similarly, the user can elect to transfer 718 some or all of the funds in the DDA 714 to the wagering account 712. As such the balance of the DDA 714 will be shown to decrease by the same amount that the wagering account 712 is increased. Such transfer 718 can also occur via the same closed-loop network established between the betting and gaming environment 700 and the financial institution holding the DDA 714.

If DDA activity 730 occurs, the available balance of the DDA 714 will be decreased. While a variety of DDA activities 730 can occur, example types of transaction 732 are illustrated as point of sale (POS) transactions, ATM transactions, and withdrawals. As is schematically shown in FIG. 1, in accordance with various embodiments, the online betting and gaming environment 700 can allow for funds withdraws 740 from the online wagering account 712. Example withdraw types 742 include check, ACH, wire transfer, and online payment services. The online betting and gaming environment 100 can also allow for fund withdraws 744 from the DDA 714. Example withdraw types 746 include check, ACH and wire transfer.

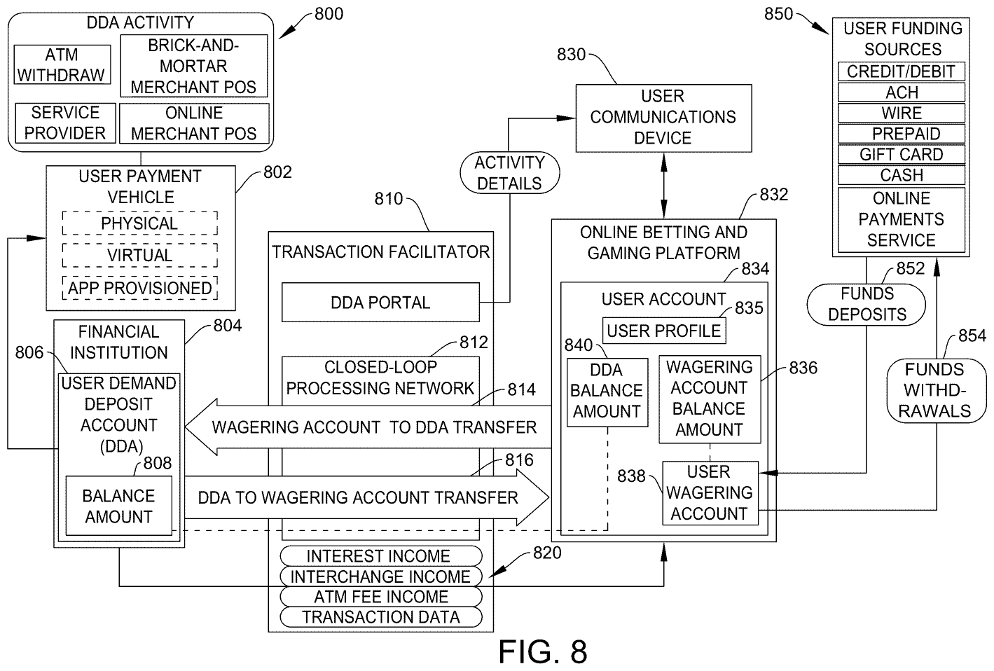

FIG. 8 depicts another example system diagram of an example transaction facilitator 810 enabling funds transfers over a closed-loop processing network 812 in accordance with one non-limiting embodiment. In some embodiments, the closed-loop processing network 812 is SPAN, a priority bi-directional closed loop network, operated by Sightline Payments LLC. The closed-loop processing network 812 can allow for closed, secure messaging between a financial institution 804 and the online betting and gaming platform 832. Such messaging can be used to enable fund transfers 814, 816 between a DDA 806 and the user wagering account 838.

In accordance with some embodiments, a user can initially interact with the online betting and gaming platform 832 via a user communication device 830. The user communication device 830 can be, for example, a smartphone, laptop computer, tablet computer, desktop computer, gaming console, VR console, kiosk, or any other communications device that can enable suitable network communications with the online betting and gaming platform 832. In some embodiments, the user can download a mobile application on their user communication device 830 allowing them to interact with the online betting and gaming platform 832. In some embodiments, the user may navigate to a website using a web browser application on their user communication device 830 to interact with the online betting and gaming platform 832. In some embodiments, the user communication device 830 can be a kiosk or dedicated handheld device that is specially configured to interact with the online betting and gaming platform 832. In any event, the user can interact with the online betting and gaming platform 832 and begin an enrollment process.

During the enrollment process, information can be collected from the user that seeks to reduce fraud and money laundering and identify terrorist financing. Gathering information such as name, date of birth, address, identification number, etc. may be required to comply with various regulations and is generally referred to as a Know Your Customer (KYC) process. Once the user has satisfied the KYC process, as well as any other enrollment procedures of the online betting and gaming platform 832, a user account 834 can be created. As part of the enrollment process, an online wagering account 838 can be created for the user, which has a balance amount 836. The online betting and gaming platform 832 can be the system of record for the account and the online wagering account 838 can be tied to a user account 234. The user account 234 can generally include or otherwise be associated with a user profile 835 and the wagering account 238.

In accordance with the present disclosure, upon satisfying the KYC process, the transaction facilitator 810 can create a DDA 806 at the financial institution 804 on behalf of the user. More particularly, information collected by the online betting and gaming platform 832 during the enrollment process can be passed to the financial institution 804 by the transaction facilitator 810 via API calls, or other suitable techniques. In some embodiments, a user payment vehicle 802 can be issued to the user that is associated with the DDA 206. The type of payment vehicle 810 issued to the user can vary based on implementation, but in some embodiments the payment vehicle is a physical card, a virtual card, and/or a payment vehicle provisioned in a mobile application. Moreover, in some embodiments the payment vehicle 802 can be branded with a brand associated with the online betting and gaming platform 832, for example. The DDA 806 can have a balance amount 808, which represents the balance of funds available to the user for withdrawal or other DDA activities 800, such as POS transactions, payment for services, online transactions, ATM withdrawals, and so forth.

In accordance with the present embodiment, the balance amount 808 can be graphically presented in the user account 834 as DDA balance amount 840. Accordingly, the user can be informed as to the balance of their DDA 806 and the balance of their wagering account 838. The user can increase the balance amount 836 of their wagering account 838 with a fund deposit 852 from any of a variety of user funding sources 850. By way of example, via interactions with an interface of the online betting and gaming platform 832, the user can provide information for a credit or debit card, or other funding source. Non-limiting examples of funding sources 850 are schematically depicted in FIG. 8. Upon receiving the funds into the wagering account 838, the balance amount 836 can be increased and be made available for wagering.

The user can utilize the payment vehicle 802 for various DDA activity 800, such as ATM withdraws, point-of-sale transactions, and so forth. At least some of these transactions can be open-loop credit or debit transactions. The user can also optionally withdraw funds from the DDA 806 using ACH transfers, wire transfers, and the like. In any event, any such DDA activity 800 will decrease the balance amount 808. In response to the DDA activity 800, the DDA balance amount 840 presented to the user in the user account 834 can be updated accordingly.

Moreover, in some embodiments, the online betting and gaming platform 832 can enjoy a number of benefits from the system and methods described herein, including receiving additional revenue and consumer data 820. Not only can patron churning of funds be reduced, the online betting and gaming platform 832 can receive at least some interest income on the DDAs of its user base, as well as receive at least some interchange income from a user's use of the payment vehicle 802, as well as at least some of the ATM fees charged to the user during ATM transactions. Additionally, the online betting and gaming platform 832 can receive insightful data on the user's spending habits, including where, when, and how users spend the funds in their DDA. Such data can be gleaned from the transaction information that is collected when a user utilizes their payment vehicle 802 to access funds in the DDA 806. This information can include merchant identifiers, merchant category codes, transaction amounts, transaction dates, and so forth.

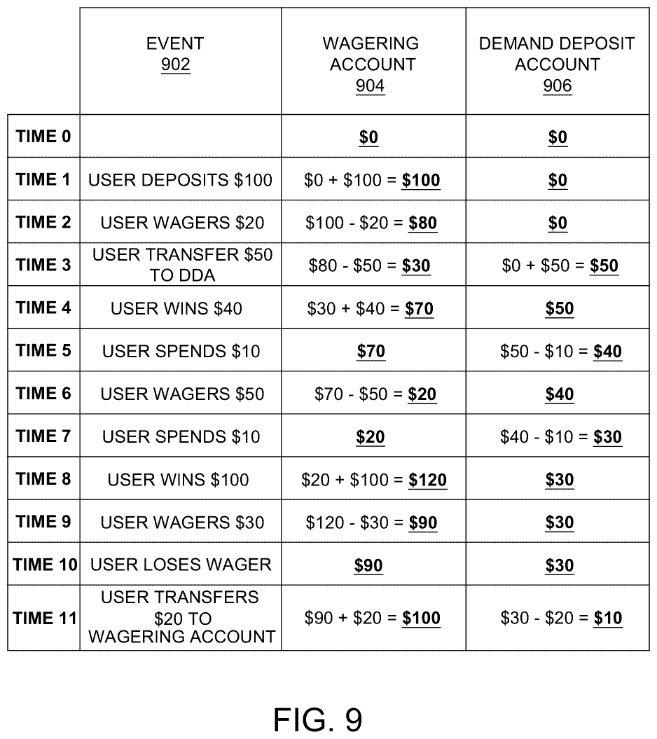

FIG. 9 schematically depicts a progression of a balance of a wagering account 904 of a gaming environment and a balance of a demand deposit account 906 over time based various events 902 in accordance with one non-limiting embodiment.

At Time 0, the real-time available balance of the online wagering account is $0.00 and the real-time available balance of the DDA is $0.00. This may occur, for example, at the account formation stage or after a user has depleted their balances.

At Time 1, the user deposits $100 from a funding source, such as a credit/debit card, an ACH transfer, or other suitable source. Accordingly, the real-time available balance of the wagering account is increased to $100.

At Time 2, the user wagers $20 via interactions with the online betting and gaming environment. Accordingly, the real-time available balance of the wagering account is decreased to $80.

At Time 3, the user transfers $50 using their DDA via closed-loop messaging.

Accordingly, the real-time available balance of the wagering account is decreased to $30 and the real-time available balance of the DDA increases to $50.

At Time 4, the user wins $40 based on a wager placed at Time 2. Accordingly, the real-time available balance of the wagering account is increased to $70.

At Time 5, the user spends $10 using their payment vehicle. Accordingly, the real-time available balance of the DDA is decreased to $40.

At Time 6, the user wagers $50 via interactions with the online betting and gaming environment. Accordingly, the real-time available balance of the wagering account is decreased to $20.

At Time 7, the user spends $10 using their payment vehicle. Accordingly, the real-time available balance of the DDA is decreased to $30.

At Time 8, the user wins $100 based on a wager placed at Time 6. Accordingly, the real-time available balance of the wagering account is increased to $120

At Time 9, the user wagers $30 via the interactions with the online betting and gaming environment. Accordingly, the real-time available balance of the wagering account is decreased to $90.

At Time 10, the user loses the wager placed at Time 9. Since the funds associated with the wager had already been withdrawn from the wagering account, this loss does not impact the balance of the wagering account and the balance remains at $90.

At Time 11, the user transfers $20 from their DDA to their wagering account. Accordingly, the real-time available balance of the wagering account is increased to $100 and the real-time available balance of the DDA decreases to $10.

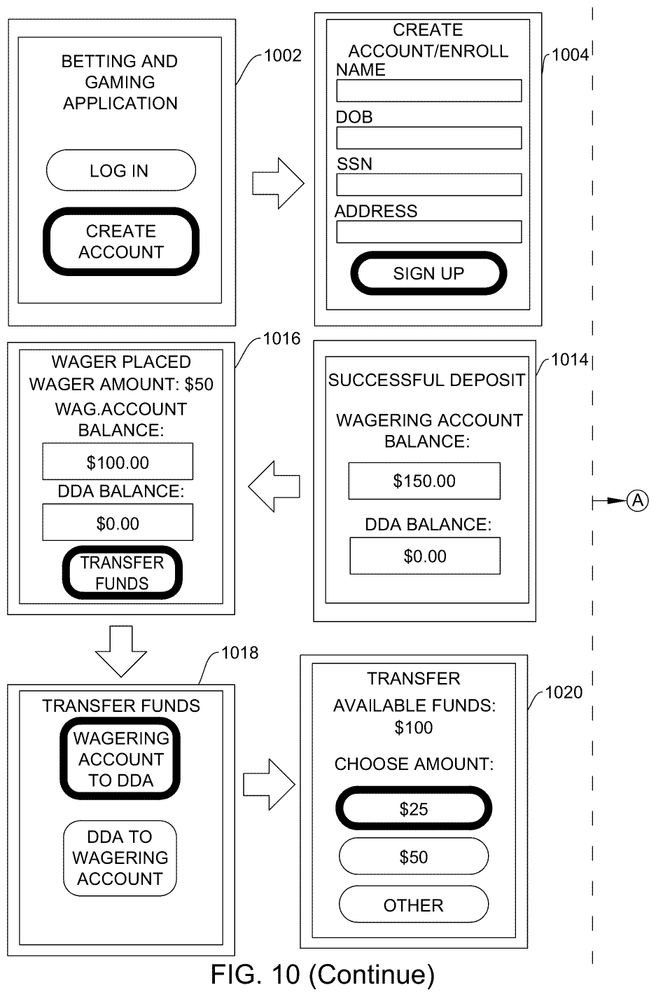

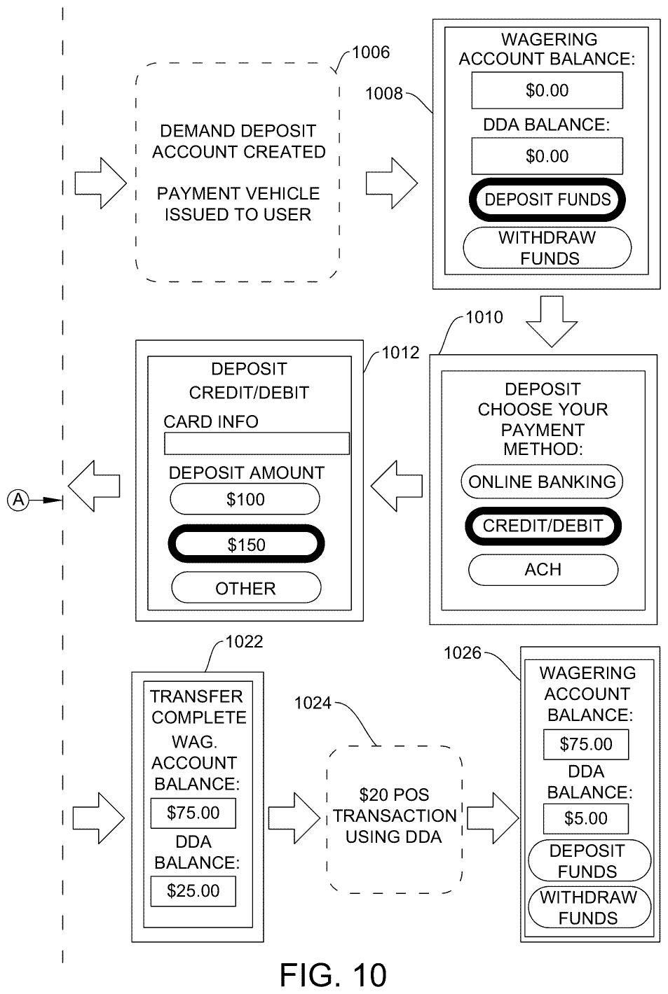

FIG. 10 schematically depicts example interfaces of a betting and gaming platform over time in accordance with one non-limiting embodiment. The interfaces can be presented, for example, on a communication device operated by a user, such as a mobile computing device, kiosk, or other device. At interface 1002, the user is presented with the option to log in or create an account with the betting and gaming platform. The “create account” option is selected, which causes interface 1004 to be presented to the user. The interface 1004 can request information from the user that is necessary for the account creation process. Once the required information has been provided by the user, the user can select the “sign up” feature. As provided above, attempting to create an account on the betting and gaming platform can trigger a KYC check. Once the KYC check is satisfied, a demand deposit account can be created at 1006. Additionally, as shown, a payment vehicle associated with the demand deposit account can be issued to the user.

At interface 1008, a balance amount of the user's wagering account is presented to the user and the balance amount of the user's DDA is presented to the user. The user has selected the “deposit funds” option. Selecting the deposit funds option can cause interface 1010 to be displayed, which generally allows the user to identify the type of funding source. Selecting the “credit/debit” funding source can cause interface 1012 to be displayed which generally allows the user to input information regarding the fund source (such as card number, expiration date, CCV, etc.). As is to be appreciated, the particular information requested via the interface will depend on the type of funding source. In the illustrated embodiment, the user has opted to fund the wagering account with an initial deposit of $150 from the funding source. After the transaction has been processed, interface 1014 can convey to the user that the wagering account balance has been increased by the amount of funds deposited. The balance amount of the DDA remains unchanged. At interface 1016, the user has placed a wager on the betting and gaming platform and the wagering account balance has been decreased accordingly. The user has also selected the transfer funds option to initiate a funds transfer between their wagering account and their DDA.

At interface 1018, the user is presented with the option to transfer funds from their wagering account to their DDA or their DDA to their wagering account. The user has selected the wagering account to DDA option. At 1020, the available balance of the wagering account can be presented and the user can indicate the amount of funds to be transferred to their DDA. As shown in interface 1020, the user has opted to transfer $25. At interface 1022, the user can be presented with withdraw options, with the “ACH” option being selected in FIG. 10. At interface 1024, the user is presented with a transfer complete interface, indicating that the balance of the DDA has been increased by $25 and the balance of the wagering account has been decreased by $25. As provided above, this balance transfer can processed in substantially real-time over a bi-directional closed loop network. As is to be appreciated, while FIG. 10 depicts the transfer of funds from the wagering account to the DDA, in other embodiments the user can also transfer funds from the DDA to the wagering account. At 1024, the user performs a $20 point-of-sale transaction using their DDA. At interface 1026, this transaction is reflected in the available balance of the DDA.

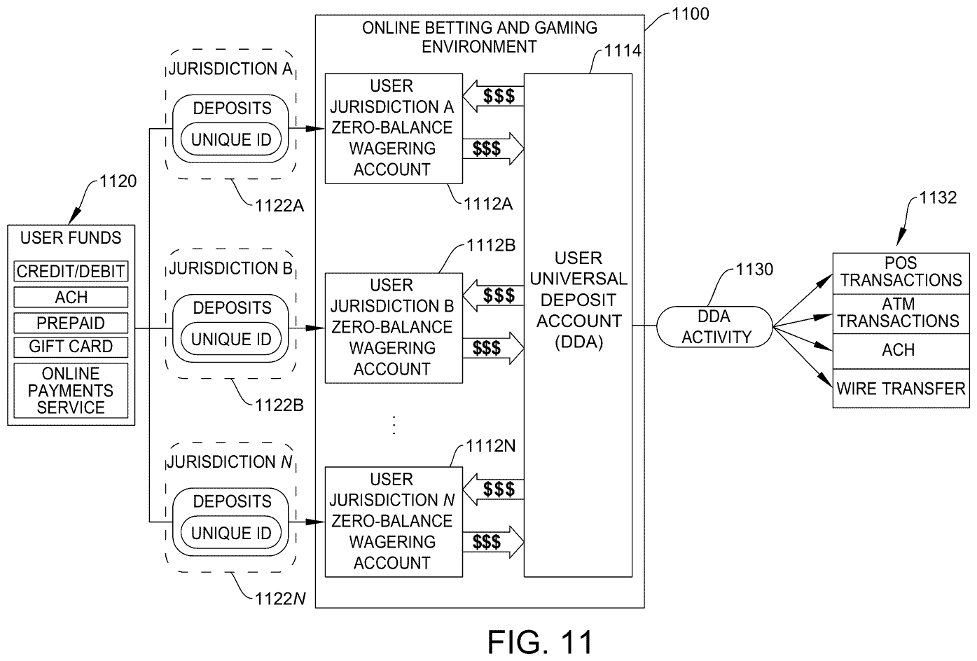

FIG. 11 depicts an example system diagram of an example online betting and gaming environment 1100 leveraging zero-balance wagering accounts 1112A-N in accordance with one non-limiting embodiment. In accordance with this embodiment, subsequent to an enrollment process a universal DDA 1114 can be created on behalf of a user. The universal DDA 1114 can be created at a financial institution and enjoy various benefits, such as deposit insurance provided by the Federal Deposit Insurance Corporation (FDIC). Additionally, funds in the DDA can be withdrawn at any time without advance notice required and typically have no limitations on withdrawals or transfer. Upon creation of the universal DDA 1114, a payment vehicle can also be issued to the user (or otherwise provisioned) to allow for ease of access to the funds in the DDA 1114.

In accordance with present disclosure, one or more zero-balance wagering accounts 112A-N can be formed that are each associated with a respective jurisdiction 1122A-N. Each jurisdiction 1122A-N can a state (i.e., Iowa, Pennsylvania, etc.), or other type of geographic region or area, although this disclosure is not so limited. If a user enrolls while physically within Jurisdiction A (as can be determined based on geolocation information provided by their mobile communications device), a zero-balance wagering account tied to Jurisdiction A can be formed on behalf of the user. Subsequently, should the user physically travel to a second jurisdiction and wish to participate in wagering activities in the second jurisdiction, a new zero-balance wagering account tied to that second jurisdiction can be formed. Through interactions with the online betting and gaming environment 1100, such as via an interface presented on a user communications device, the user can initiate deposits 1122A-N into the wagering account for the jurisdiction in which they are physically located at the time of deposit. These funds can come from a source of user funds 1120. While FIG. 11 schematically illustrates credit/debit, ACH, prepaid accounts, gift card accounts, online payment service (i.e., VENMO, PAYPAL, and the like) as example user fund sources, any suitable source of user funds 120 can be leveraged. These deposits can be associated with a unique ID that indicate, for example, the type of funds (i.e., sourced from a credit card), the state from which funds were deposited, and so forth. Upon being received into the respective zero-account wagering account, they can be transferred to the user universal DDA 1114. These funds can be used for a variety of DDA activities 1130, with example types of transaction 1132 illustrated as point of sale (POS) transactions, ATM transactions, and withdrawals.

Should the user wish to place a wager while the user is physically within Jurisdiction B, for example, funds from the universal DDA 1114 can first be transferred to the Jurisdiction B zero-balance wagering account 1112B. These funds can then be used to place the wager with the online betting and gaming environment 1100. As such, the balance in the wagering account 1112B typically remains at a zero-balance until the user wishes to place a wager while physically within the jurisdiction associated with that wagering account. In operation, the user may be unaware of the existence of the various zero-balance wagering accounts. Instead, from a user experience point of view, the funds submitted to the online betting and gaming environment for a wager would appear to be sourced directly from the universal DDA 1114, as opposed to being transferred through a zero-balance wagering account. Furthermore, the unique IDs associated with each deposit can assist with regulatory compliance. By way of example, certain jurisdictions might limit or prohibit funds from particular sources of funds (i.e., credit cards) being used for wagering activities. The presently disclosed systems and methods can therefore allow for uniquely tracking funds in/out of each wagering account and in/out of the universal DDA to aid in regulatory compliance by the entities involved with the transactions.

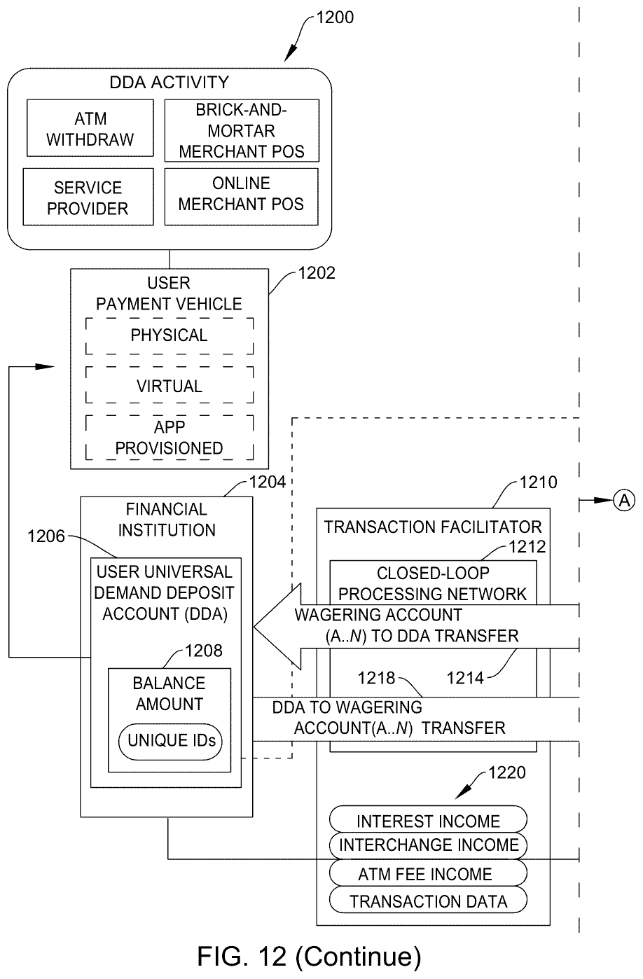

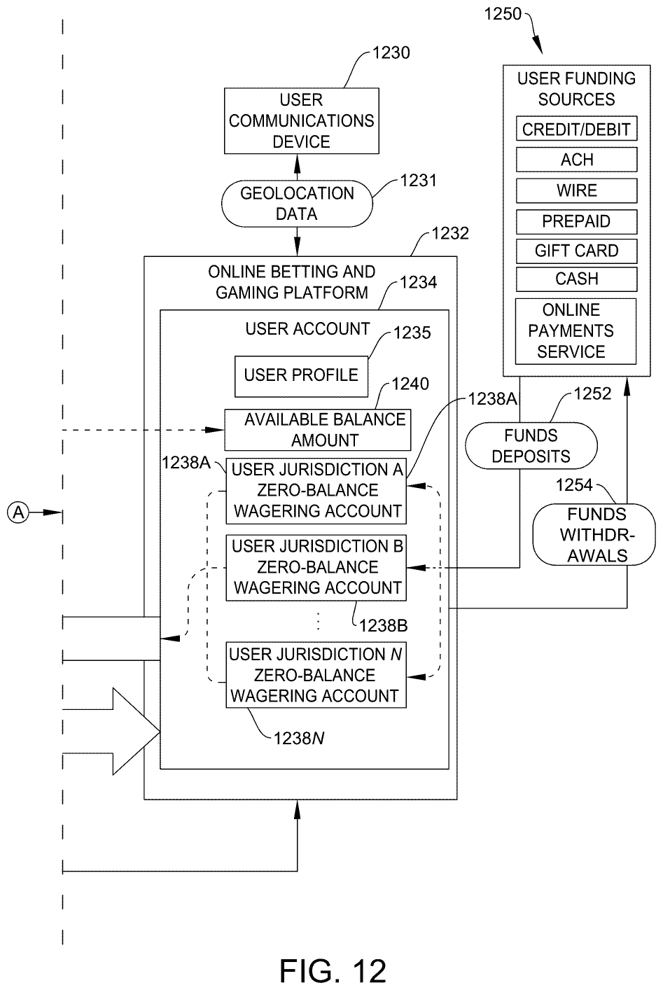

FIG. 12 depicts another example system diagram of an example transaction facilitator 1210 enabling the use of universal demand deposit account 1203 over a closed-loop processing network 1212 in accordance with one non-limiting embodiment. In some embodiments, the closed-loop processing network 1212 is SPAN, a priority bi-directional closed loop network, operated by Sightline Payments LLC. The closed-loop processing network 1212 can allow for closed, secure messaging between a financial institution 804 and the online betting and gaming platform 1232. Such messaging can be used to enable fund transfers 1214, 1216 between a universal DDA 1206 and each of a plurality of zero-balance wagering accounts 1238A-N.

In accordance with some embodiments, a user can initially interact with the online betting and gaming platform 1232 via a user communication device 1230. The user communication device 1230 can be, for example, a smartphone, laptop computer, tablet computer, desktop computer, gaming console, VR console, kiosk, or any other communications device that can enable suitable network communications with the online betting and gaming platform 1232. In some embodiments, the user can download a mobile application on their user communication device 1230 allowing them to interact with the online betting and gaming platform 1232. In some embodiments, the user may navigate to a website using a web browser application on their user communication device 1230 to interact with the online betting and gaming platform 1232. In some embodiments, the user communication device 1230 can be a kiosk or dedicated handheld device that is specially configured to interact with the online betting and gaming platform 1232. Geolocation data 1231 associated with the user can also be received by the online betting and gaming platform 1232. In some embodiments, this data is collected by the user communications device 1230. In other embodiments, a third-party provider can be used to identify a geographic jurisdiction associated with the user. In any event, the user can interact with the online betting and gaming platform 1232 and begin an enrollment process.

During the enrollment process, information can be collected from the user that seeks to reduce fraud and money laundering and identify terrorist financing. Gathering information such as name, date of birth, address, identification number, etc. may be required to comply with various regulations and is generally referred to as a Know Your Customer (KYC) process. Once the user has satisfied the KYC process, as well as any other enrollment procedures of the online betting and gaming platform 1232, a user account 1234 can be created. As part of the enrollment process, a wagering account tied to that particular jurisdiction can be created for the user, such as a zero-balance wagering account 1238A for Jurisdiction A (assuming the user in physically within Jurisdiction A at the time of enrollment). The online betting and gaming platform 122 can be the system of record for the account and the zero-balance wagering account 1238A can be tied to a user account 1234. The user account 1234 can generally include or otherwise be associated with a user profile 1235 and the zero-balance wagering account(s) 1238A-N associated with the user. As is to be appreciated, some users might only have a single zero-balance wagering account while others might have a plurality of zero-balance wagering accounts tied to their user account.

In accordance with the present disclosure, upon satisfying the KYC process, the transaction facilitator 1210 can create a universal DDA 1206 at the financial institution 1204 on behalf of the user. More particularly, information collected by the online betting and gaming platform 1232 during the enrollment process can be passed to the financial institution 1204 by the transaction facilitator 1210 via API calls, or other suitable techniques. In some embodiments, a user payment vehicle 1202 can be issued to the user that is associated with the universal DDA 1206. The type of payment vehicle 1210 issued to the user can vary based on implementation, but in some embodiments the payment vehicle is a physical card, a virtual card, and/or a payment vehicle provisioned in a mobile application. Moreover, in some embodiments the payment vehicle 1202 can be branded with a brand associated with the online betting and gaming platform 1232, for example. The universal DDA 1206 can have a balance amount 1208, which represents the balance of funds available to the user for withdrawal or other DDA activities 1200, such as POS transactions, payment for services, online transactions, ATM withdrawals, and so forth.

In accordance with the present embodiment, the balance amount 1208 can be graphically presented in the user account 1234 as DDA balance amount 1240. To fund their account, the user can increase the balance amount of one of their zero-balance wagering accounts 1238A-N with a fund deposit 1252 from any of a variety of user funding sources 1250. By way of example, via interactions with an interface of the online betting and gaming platform 1232, the user can provide information for a credit or debit card, or other funding source. Non-limiting examples of funding sources 1250 are schematically depicted in FIG. 12. A identifier can be tied to the inbound funds for tracking and compliance purposes. For example, the identifier can indicate the source type of the funds, the jurisdiction from which the funds were paid, and so forth. Upon receiving the balance amount of the wagering account tied to the jurisdiction in which the user is located can be increased. The funds, accompanied by the identifier, can then be transferred via a wagering account to DDA transfer 1214 from that wagering account to the universal DDA 1208. The use of the identifier allows for various types of tracking and reporting to be executed. For example, the universal DDA 1206 may have a balance of $1000. Using the identifier information that accompanied each deposit, it can be determined that $600 was sourced from a DDA while the user was in Jurisdiction A while $400 was sourced from a credit card while the user was in Jurisdiction B.

When a user wishes to place a wager, it is first determined the jurisdiction in which the wager will be placed. This determination can be made, for example, from the geolocation data 1231 received from the user communications device 1230. Assuming the user is physically within Jurisdiction B, a transfer 1218 would be initiated to transfer funds from the universal DDA 1206 into the zero-balance wagering account 1238B for Jurisdiction B. The funds can then be utilized by the online betting and gaming platform 1232 for the wager. It is noted that the funds used for the wager might have been initially received from the user while they were in a jurisdiction other than Jurisdiction B.

In any event, funds can generally flow through each of the zero-balance wagering accounts—but a balance of funds is not consistently maintained in any of zero-balance wagering accounts. During a funding event, the funds flow from a funding source, through the appropriate zero-balance wagering account and to the universal DDA. During a wagering event, the funds flow from the universal DDA, through the appropriate zero-balance wagering account and to the betting and gaming platform. I

Additionally, similar to previous embodiments, the user can utilize the payment vehicle 1202 for various DDA activities 1200, such as ATM withdraws, point-of-sale transactions, and so forth. At least some of these transactions can be open-loop credit or debit transactions. The user can also optionally withdraw funds from the DDA 1206 using ACH transfers, wire transfers, and the like. In any event, any such DDA activity 1200 will decrease the balance amount 1208. In response to the DDA activity 1200, the DDA balance amount 1240 presented to the user in the user account 1234 can be updated accordingly.

Moreover, in some embodiments, the online betting and gaming platform 1232 can enjoy a number of benefits from the system and methods described herein, including receiving additional revenue and consumer data 1220. Not only can patron churning of funds be reduced, the online betting and gaming platform 1232 can receive at least some interest income on the DDAs of its user base, as well as receive at least some interchange income from a user's use of the payment vehicle 1202, as well as at least some of the ATM fees charged to the user during ATM transactions. Additionally, the online betting and gaming platform 1232 can receive insightful data on the user's spending habits, including where, when, and how users spend the funds in their DDA. Such data can be gleaned from the transaction information that is collected when a user utilizes their payment vehicle 1202 to access funds in the DDA 1206. This information can include merchant identifiers, merchant category codes, transaction amounts, transaction dates, and so forth.

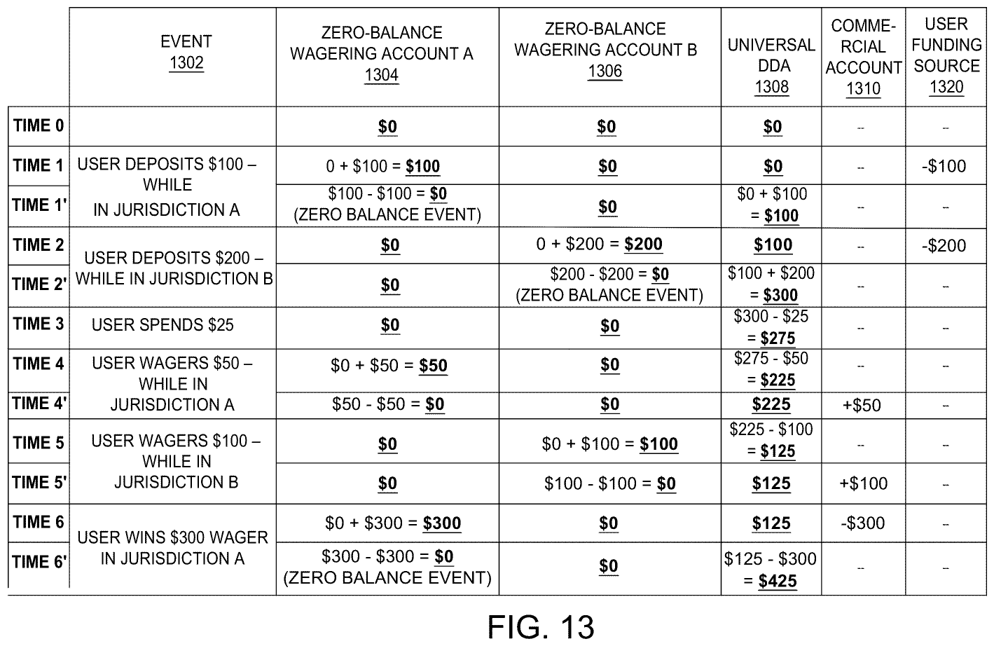

FIG. 13 schematically depicts a progression of a balance of zero-balance wagering accounts 1304 and 1306 of a gaming environment and a balance of a universal DDA over time based various events in accordance with one non-limiting embodiment.

At Time 0, the real-time available balance of the zero-balance wagering account A is $0.00, the real-time available balance of the zero-balance wagering account B is $0.0, and the real-time available balance of the universal DDA is $0.00.

At Time 1, the user deposits $100 from a user funding source 1320, such as a credit/debit card, an ACH transfer, or other suitable source, while in Jurisdiction A. Accordingly, the real-time available balance of the zero-balance wagering account A is increased to $100. At Time 1′, the $100 is transferred from the zero-balance wagering account A to the universal DDA as a zero-balance event to increase its balance to $100. An identified can be associated with the deposit for compliance purposes.

At Time 2, the user deposits $200 from a user funding source 1320, such as a credit/debit card, an ACH transfer, or other suitable source, while in Jurisdiction B. Accordingly, the real-time available balance of the zero-balance wagering account B is increased to $200. At Time 2′, the $200 is transferred from the zero-balance wagering account B to the universal DDA as a zero-balance event to increase its balance to $300. An identified can be associated with the deposit for compliance purposes.

At Time 3, the user spends $25 using a payment vehicle tied to their universal DDA. Accordingly, the real-time available balance of the universal DDA decreases to $275.

At Time 4, while in Jurisdiction A the user seeks to wagers $50 so the balance of the universal DDA is decreased by $50 and the balance of the zero-balance wagering account A is increased to $50. At Time 4′, the wager is placed to return the balance of the zero-balance wagering account to $0. The commercial account 1310 receives the $50 wager.

At Time 5, while in Jurisdiction B the user seeks to wagers $100 so the balance of the universal DDA is decreased by $100 and the balance of the zero-balance wagering account B is increased to $100. At Time 5′, the wager is placed to return the balance of the zero-balance wagering account to $0. The commercial account 1310 receives the $100 wager.

At Time 6, the user wins $300 based on a wager placed at Time 4. Accordingly, the balance of the zero-balance wagering account A is increased to $300 at Time 6. At Time 6′, the $300 is transferred from the zero-balance wagering account A to the universal DDA as a zero-balance event to increase its balance to $425.

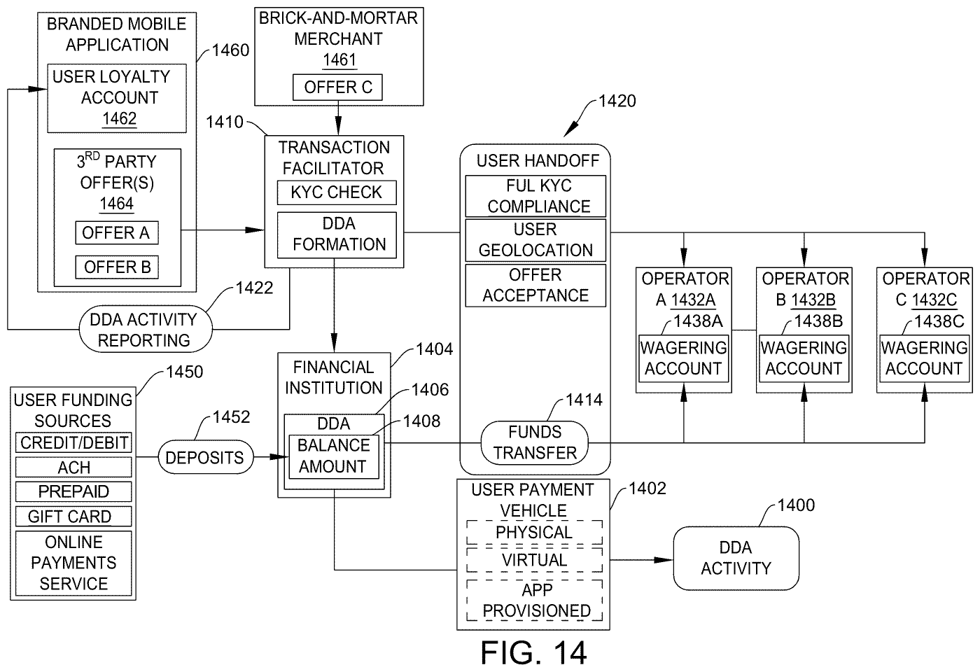

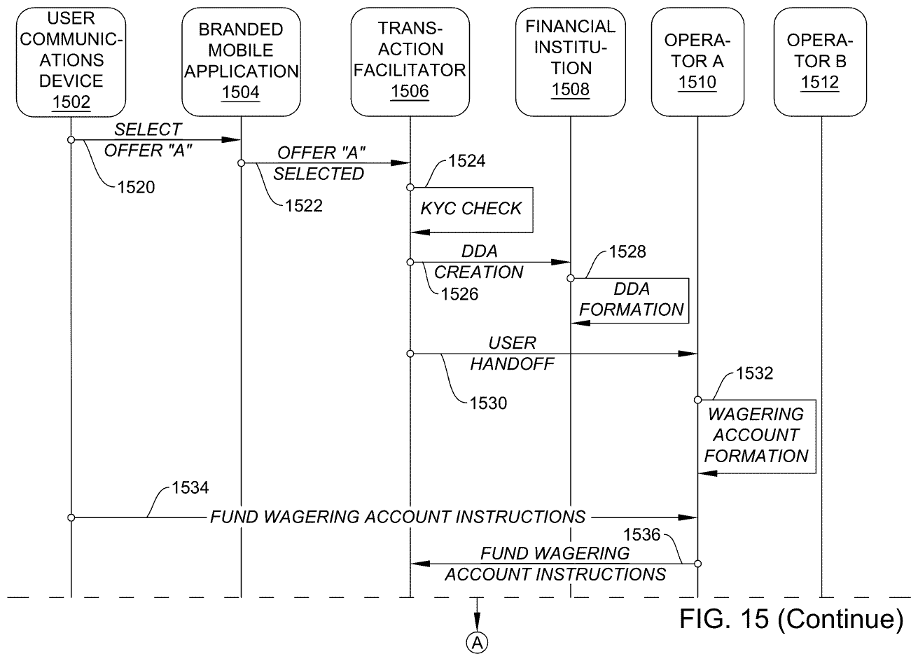

FIG. 14 depicts an example system diagram for formation of a user demand deposit account 1406 and facilitating handoff of the user to gaming operators 1432A-C for offer redemption and wagering in accordance with one non-limiting embodiment. A branded mobile application 1460 can be accessed by a user via suitable communication device. The mobile application 1460 can track, for example, a loyalty account 1462 of the user. In accordance with the present disclosure an offer associated with a gaming operator can be presented to the user via the branded mobile application 1460. The gaming operator can be, for example, an online sports betting platform, an online casino platform, a brick-and-mortar casino, among other types of gaming operators. Additionally or alternatively, in some embodiments, offers can also be presented a merchant brick-and-mortar location 1461. When a user seeks to redeem the offer, they can be routed to a transaction facilitator 1410 via their communications device. The transaction facilitator 1410 can then collect information from the user to conduct a KYC check. Upon a successful KYC check, the transaction facilitator 1410 can automatically then facilitate a DDA formation through messages with a financial institution 1404.

In some embodiments, a user payment vehicle 1402 can be issued to the user that is associated with the DDA 1406. The type of payment vehicle 1410 issued to the user can vary based on implementation, but in some embodiments the payment vehicle is a physical card, a virtual card, and/or a payment vehicle provisioned in a mobile application. Moreover, in some embodiments the payment vehicle 1402 can be branded with a brand associated with the mobile application, for example. The DDA 1406 can have a balance amount 1408, which represents the balance of funds available to the user for withdrawal or other DDA activities 1400, such as POS transactions, payment for services, online transactions, ATM withdrawals, and so forth. Such DDA activity can be reported 1422 to the user loyalty account 1462 so that the user can receive various rewards, offers, or benefits.

The user can increase the balance amount 1408 of the DDA 1406 with a fund deposit 1452 from any of a variety of user funding sources 1450. Non-limiting examples of funding sources 1450 are schematically depicted in FIG. 14. Upon receiving the funds into the DDA 1406, the balance amount 1408 can be increased.

Upon completing the KYC process, the transaction facilitator 1410 can perform a user handoff 1420 to gaming operator associated with the offer being accepted. As part of the handoff, the gaming operator can receive a fully KYC's user, the user's geolocation information, and an indication of the offer accepted. The receiving gaming operator 1432A-C can also form a wagering account 1438A-C for the user, which can be funded via a funds transfer 1414 from the DDA 1406. In some embodiments, the funds transfer 1414 is part of the user handoff 1420, although this disclosure is not so limited.

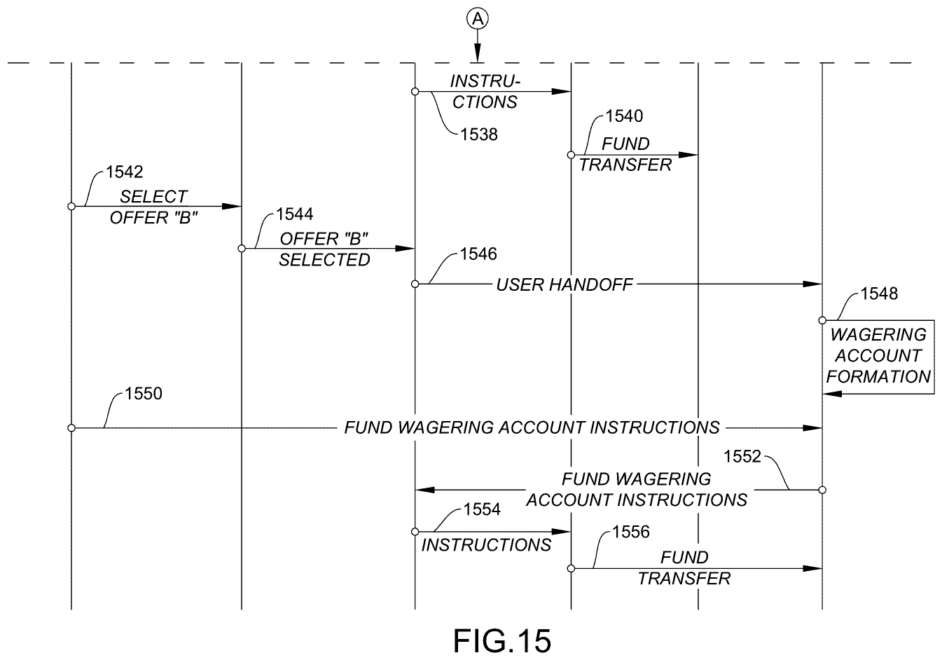

FIG. 15 is an example message sequence chart (MSC) in accordance with one non-limiting embodiment. The MSC schematically depicts a user communications device 1502, a branded mobile application 1504, a transaction facilitator 1506, a financial institution 1508, an operator A 1510, and an operator B 1512.

At 1520, the user selects offer “A” on the branded mobile application 1504, which is an offer associated with gaming operator A 1510.

At 1522, the branding mobile application 1504 informs the transaction facilitator 1506 of the selection by the user.

At 1524, the transaction facilitator 1506 performs a KYC check for the user.

At 1526, upon a successful KYC check, the transaction facilitator 1506 initiates a DDA creation at the financial institution 1508 (i.e., via API calls between the transaction facilitator 1506 and the financial institution 1508).

At 1528, a DDA is formed at the financial institution 1508 for the user.

At 1530, the transaction facilitator 1506 performs a user handoff to the operator A 1510.

At 1532, the operator A 1510 forms a wagering account for the user leveraging the KYC check previously performed by the transaction facilitator 1506.

At 1534, the user provides funding instructions to the operator A 1510 to load their wagering account.

At 1536, the operator A 1510 communicates the instructions to the transaction facilitator 1506.

At 1538, the instructions are sent via a closed-loop communication channel to the financial institution 1508.

At 1540, a funds transfer is initiated between the user's DDA and their wagering account at the operator A 1510.

At 1542, the user selects offer “B” on the branded mobile application 1504, which is an offer associated with gaming operator B 1512

At 1544, the branding mobile application 1504 informs the transaction facilitator 1506 of the selection by the user.

At 1546, the transaction facilitator 1506 performs a user handoff to the operator B 1512.

At 1548, the operator B 1512 forms a wagering account for the user leveraging the KYC check previously performed by the transaction facilitator 1506

At 1550, the user provides funding instructions to the operator B 1512 to load their wagering account.

At 1552, the operator B 1512 communicates the instructions to the transaction facilitator 1506.

At 1554, the instructions are sent via a closed-loop communication channel to the financial institution 1508.

At 1556, a funds transfer is initiated between the user's DDA and their wagering account at the operator B 1512.

Any element expressed herein as a means for performing a specified function is intended to encompass any way of performing that function, including a combination of elements that perform that function. Furthermore, the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A non-transitory computer-readable medium may also include memory storage that may be physical, virtual, permanent, temporary, semi-permanent and/or semi-temporary.

A “computer,” “computer system,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as tracking demand for processing power from different machines, prioritizing and scheduling tasks based on network demand, and/or providing backup contingency in the event of component failure or reduction in operability.

The examples presented herein are intended to illustrate potential and specific implementations. It can be appreciated that the examples are intended primarily for purposes of illustration of the invention for those skilled in the art. No particular aspect or aspects of the examples are necessarily intended to limit the scope of the present disclosure. No particular aspect or aspects of the examples of system architectures, table layouts, or report formats described herein are necessarily intended to limit the scope of the disclosure.

In general, it will be apparent to one of ordinary skill in the art that various embodiments described herein, or components or parts thereof, may be implemented in many different embodiments of software, firmware, hardware, or modules thereof. The software code or specialized control hardware used to implement some of the present embodiments is not limiting to the present invention. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present disclosure based on the description herein with only a reasonable effort and without undue experimentation.

In various embodiments, the systems and methods described herein may be configured and/or programmed to include one or more of the above-described electronic, computer-based elements and components. In addition, these elements and components may be particularly configured to execute the various rules, algorithms, programs, processes, and method steps described herein.

While various embodiments have been described herein, it should be apparent that various modifications, alterations and adaptations to those embodiments may occur to persons skilled in the art with the attainment of some or all of the advantages of the present disclosure. The disclosed embodiments are therefore intended to include all such modifications, alterations, and adaptations without departing from the scope and spirit of the present disclosure as set forth in the appended claims.

1. A synchronized account management system, comprising:
an wagering account maintained by a gaming environment, wherein the gaming environment is a physical brick and mortar casino, and wherein the wagering account has a balance amount;
a demand deposit account (DDA) maintained by a financial institution, wherein the demand deposit account has a ledger balance amount; and
a transaction facilitator in networked communication with the gaming environment and the financial institution, wherein responsive to a wagering account deposit or withdrawal, the transaction facilitator facilitates synchronization of the ledger balance amount of the DDA based on the wagering account deposit or withdrawal, and wherein responsive to DDA activity, the transaction facilitator facilitates synchronization of the balance amount of the online wagering account based on the DDA activity.

2. The synchronized account management system of claim 1, wherein the wagering account is created subsequent to a player enrollment process within the gaming environment by a player.

3. The synchronized account management system of claim 2, wherein the DDA is automatically created for the player at the financial institution responsive to the enrollment process within the gaming environment by the player.

4. The synchronized account management system of claim 3, comprising a payment vehicle associated with the DDA and issued to the player.

5. The synchronized account management system of claim 3, wherein the DDA is created via application programming interface (API) calls to the financial institution, wherein the API calls include information received from the player during the enrollment process.

6. The synchronized account management system of claim 5, wherein the information received from the player comprises a player name, date of birth, address, and identification number.

7. The synchronized account management system of claim 1, comprising a closed-loop processing network maintained by the transaction facilitator, wherein the transaction facilitator utilizes the closed-loop processing network to synchronize the ledger balance amount of the DDA and the balance amount of the online wagering account.

8. The synchronized account management system of claim 7, wherein the synchronization of the ledger balance amount of the DDA and the balance amount of the wagering account occurs in real-time.

9. A computer-based method of account management between an online wagering account and a demand deposit account via closed-loop communication channels, the method performed by one or more computing devices comprising instructions stored in a memory, which when executed by one or more processors of the one or more computing devices, cause the one or more computing devices to perform the method comprising:
receiving from an online betting and gaming platform player information associated with a player, wherein the player information is received from the player during an enrollment process, wherein a wagering account for the player is created and maintained by the online betting and gaming platform, and wherein the wagering account has a balance amount;
providing to a financial institution the player enrollment information, wherein based on the player information a demand deposit account (DDA) for the player is created and maintained by the financial institution, wherein the DDA has a ledger balance amount;
displaying to the player, the ledger balance amount of the DDA and the balance amount of the wagering account;
responsive to a wagering account deposit by the player on the online betting and gaming platform, increasing the balance amount of the wagering account based on an amount of the wagering account deposit;
responsive to a transfer request, transferring at least a portion of the balance amount of the wagering account to the DDA to increase the ledger balance amount based on an amount requested in the transfer request.

10. The method of claim 9, wherein the DDA is created via application programming interface (API) calls to the financial institution, wherein the API calls include information received from the player during the enrollment process.

11. The method of claim 9, wherein the information received from the player comprises a player name, date of birth, address, and identification number.

12. The method of claim 9, responsive to a load request, transferring at least a portion of the ledger balance amount of the DDA to the wagering account to increase the balance amount of the wagering account.

13. The method of claim 9, further comprising providing consumer data to the online betting and gaming platform based on DDA activity.

14. The method of claim 13, wherein the DDA activity is any of a point of sale transaction, a payment for services, an online transaction, and an ATM withdrawal.

15. The method of claim 9, further comprising providing interchange fees to the online betting and gaming platform based on use of a payment vehicle associated with the DDA.

16. An account management system, comprising:
an online betting and gaming platform, wherein the online betting and gaming platform maintains a plurality of zero-balance wagering accounts created on behalf of a player, wherein each of the plurality of zero-balance wagering accounts is associated with a respective gaming jurisdiction of a plurality of gaming jurisdictions;
a universal demand deposit account (DDA), wherein the universal DDA stores funds on behalf of the player, wherein deposits made by the player flow through one of the plurality of zero-balance wagering accounts and into the universal DDA, wherein the one of the plurality of zero-balance wagering accounts is based on the physical location of the player at the time of the deposit, wherein when the player places a wager from within one of the plurality of gaming jurisdictions, funds flow from the universal DDA and through the zero-balance wagering account associated with the one of the plurality of gaming jurisdictions.

17. The account management system of claim 16, wherein the deposits made by the player that flow through one of the plurality of zero-balance wagering accounts and into the universal DDA funds are associated with a unique ID.

18. The account management system of claim 16, wherein the plurality of gaming jurisdictions comprises a first state and a second state, wherein gaming regulations of the first state differ from the gaming regulations of the second state.

19. The account management system of claim 16, further comprising a payment vehicle issued to the player and associated with the universal DDA.

20. The account management system of claim 16, further comprising a closed-loop processing network, wherein funds are moved between the DDA to the plurality of zero-balance wagering accounts via the closed-loop processing network.
